(19) United States
(12) Patent Application Publication
(10) Pub. No.: US 2003/0193967 A1
(43) Pub. Date: Oct. 16, 2003

(54) Method, apparatus and system for processing multimedia messages

(76) Inventors: Gregg Fenton, Northport, NY (US); Edwin Sandberg, Tyreso (SE)

Correspondence Address: Ronald W. Burns, GARDERE WYNNE SEWELL LLP, Suite 3000, 1601 Elm Street, Dallas, TX, 75201-4767, US

(21) Appl. No.: 10/319,299

(22) Filed: Dec. 13, 2002

Related U.S. Application Data
(60) Provisional application No. 60/345,956, filed on Dec. 31, 2001.

(51) Int. Cl. H04J 1/00

(52) U.S. Cl. 370/490; 370/469

(57) ABSTRACT

The present invention provides a method, apparatus and system for processing a multimedia message wherein a multimedia message is received (1202) and it is determined whether the multimedia message should be processed using a customized process (1204). If the multimedia message should be processed with the customized process, the present invention retrieves one or more customized processing instructions from a database (1208) and processes the multimedia message using the one or more customized processing instructions (1210). If, however, the multimedia message should not be processed using the customized process, the present invention processes the multimedia message using a standard process (1206). This method can be implemented using hardware or a computer program embodied on a computer readable medium wherein each block represents a code segment.

This patent application claims priority of U.S. Provisional Application No. 60/345956, filed on Dec. 31, 2001.

### TECHNICAL FIELD OF THE INVENTION

The present invention relates generally to the field of communications and, more particularly, to a method, apparatus and system for processing multimedia messages.

### BACKGROUND OF THE INVENTION

Short messaging service (“SMS”) has been very successful in the Global System for Mobile Communications (“GSM”) second generation system (“2G”). The success of SMS is due, in part, to the fact that all GSM capable devices support the SMS application level so that there is no need to check each device to determine whether or not its supports SMS applications. This easy to use service for non-real time text transmission between GSM users will be succeeded to in third generation (“3G”) mobile systems by a non-real time multimedia message service (“MMS”). The MMS will provide multimedia message capability instead of the text only capability of SMS.

Multimedia consists of one or more media elements, such as text, voice, image and video, and it is the combination of these media elements in an ordered synchronized manner that creates a multimedia presentation, which is also referred to as multimedia content. A non-real time multimedia message as observed by the user is a combination of one or more different media elements in a multimedia presentation that can be transferred between users without having to be transferred in real time.

With the popularity of the Internet and increased capability of personal computers, multimedia technology has and continues to rapidly develop to allow new capabilities, such as multimedia messages, games, presentations and services that are now considered to be a part of every day life. Moreover, the reduced size and increased capabilities of handheld devices, such as personal data assistants (“PDAs”), mobile phones and combinations thereof, have made the delivery of multimedia content to such devices more of a possibility. Efficient and effective delivery of multimedia content to such devices is not, however, a practical reality.

There is, therefore, a need for a method, apparatus and system that processes multimedia messages and is capable of supporting current and future multimedia messaging services, and exploit the advances being made in the world multimedia community, with additional mobile requirements.

### SUMMARY OF THE INVENTION

The present invention provides a method, apparatus and system that processes multimedia messages and is capable of supporting current and future multimedia messaging services, and exploit the advances being made in the world multimedia community, with additional mobile requirements. The present invention does not standardize new services themselves, but instead provides a standardized set of service capabilities and features on which the new services will be built. The present invention allows users to send and receive messages exploiting the whole array of media types available today, e.g. text, voice, images, audio, video and combinations thereof, while also making it possible to support new media types as they become available. The present invention provides, among other things, multiple media elements per single message, individual handling of message elements, different delivery methods for each message element, negotiation of different terminal and network multimedia message capabilities, notification and acknowledgment of multimedia message related events (e.g. delivery, deletion), handling of undeliverable multimedia messages, personalized multimedia message service configurations and flexible charging. The present invention provides a unified application that integrates the composition, storage, access and delivery of different media types in combination with additional mobile requirements.

The present invention provides a method for processing a multimedia message wherein the multimedia message is received and it is determined whether the multimedia message should be processed using a customized process or a standard process. If the multimedia message should be processed with the customized process, the present invention retrieves one or more customized processing instructions from a database and processes the multimedia message using the one or more customized processing instructions. If, however, the multimedia message should be processed using the standard process, the present invention processes the multimedia message using the standard process. This method can be implemented using a computer program embodied on a computer readable medium wherein each function is executed using a code segment.

The present invention also provides a system for processing a multimedia message that includes a multimedia service relay, a multimedia service server communicably coupled to the multimedia service relay, a message storage device communicably coupled to the multimedia service server and a database communicably coupled to the multimedia service relay. The database contains one or more customized processing instructions.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is an architectural overview of a Multimedia Messaging Service in accordance with one embodiment of the present invention;

FIG. 2 is an overview of a Multimedia Messaging Service in accordance with another embodiment of the present invention;

FIG. 3 is a block diagram of a logical Multimedia Messaging Service platform in accordance with one embodiment of the present invention;

FIG. 4 is a block diagram of a Multimedia Messaging Center in accordance with one embodiment of the present invention;

FIG. 5 is a block diagram showing the components of a Multimedia Messaging Center in accordance with one embodiment of the present invention;

FIG. 6 is a block diagram showing the network connectivity of a Multimedia Messaging Center in accordance with one embodiment of the present invention;

FIG. 7 is a block diagram showing a protocol framework of the Multimedia Messaging Service User Agent, Multimedia Messaging Center and External Servers in accordance with one embodiment of the present invention;

FIG. 8 is a block diagram showing a protocol framework of the Multimedia Messaging Service User Agent, Wireless Application Protocol Gateway and Multimedia Messaging Center in accordance with one embodiment of the present invention;

FIG. 9 is a block diagram showing a protocol framework of the Multimedia Messaging Service User Agent, Internet Protocol Based Gateway and Multimedia Messaging Center in accordance with one embodiment of the present invention;

FIG. 10 is a block diagram showing the communication between two Multimedia Messaging Service Environments in accordance with one embodiment of the present invention;

FIG. 11 is a message flow diagram showing the communication between two Multimedia Messaging Service Environments in accordance with one embodiment of the present invention; and

FIG. 12 is a flow chart of the Multimedia Messaging Center multimedia message processing.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. For example, in addition to telecommunications systems, the present invention may be applicable to other forms of communications or general data processing. Other forms of communications may include communications between networks, communications via satellite, or any form of communications not yet known to man as of the date of the present invention. The specific embodiments discussed herein are merely illustrative of specific ways to make and use the invention and do not limit the scope of the invention.

The present invention provides a flexible architecture that supports present and future multimedia messaging technologies and handles all message types and formats, such as fax, SMS, Multimedia, voice-mail and e-mail, in a consistent manner regardless of message type or format. The present invention also provides consistent access to the system regardless of the access point within the capabilities of networks and terminals. For example, the user can access his or her multimedia messages through a number of different access points, which may include 3G and 2G networks, fixed networks and the Internet. The present invention supports a minimum set of functionality and message media types and message content formats to ensure interoperability between different terminals and networks from the very beginning of service provisioning.

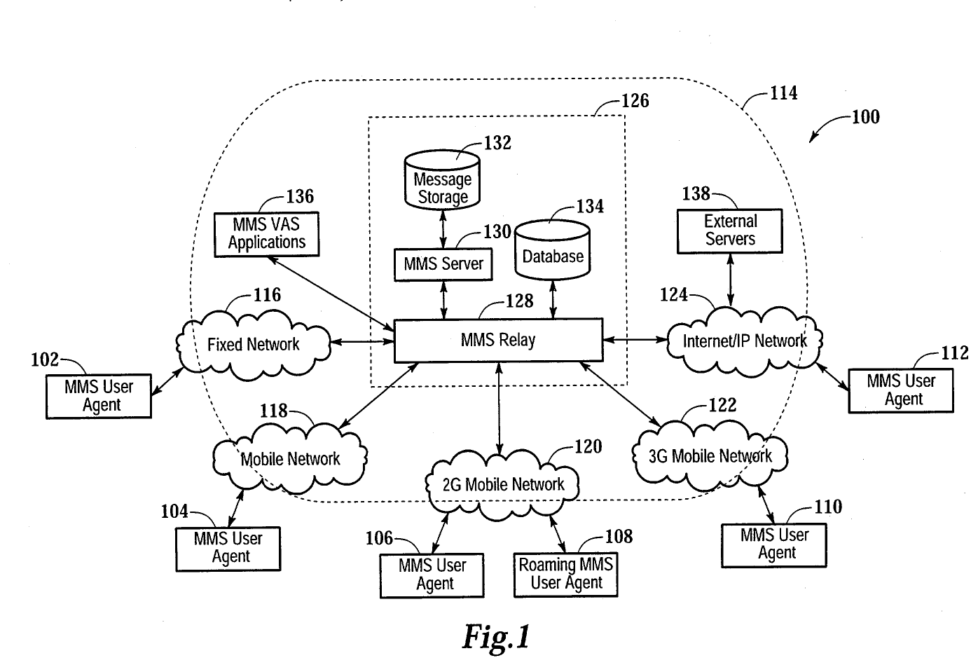

FIG. 1 is an architectural overview of a Multimedia Messaging Service (“MMS”) 100 in accordance with one embodiment of the present invention that combines different networks and network types and integrates messaging systems already existent within these networks. MMS User Agents 102, 104, 106, 108, 110 and 112 interact with the Multimedia Messaging Service Environment (“MMSE”) 114, which may comprise fixed networks 116, mobile networks 118, 2G mobile networks 120, 3G mobile networks 122 and Internet/IP networks 124. The MMS User Agents 102, 104, 106, 108, 110 and 112 reside on a UE, an MS or on an external device connected to a UE/MS. Each MMS User Agent 102, 104, 106, 108, 110 and 112 is an application layer function that provides the users with the ability to view, compose and handle multimedia messages (e.g., submitting, receiving, deleting of multimedia messages). The MMSE 114 provides all the necessary service elements, e.g. delivery, storage and notification functionality. These service elements may be located within one network or distributed across several networks or network types. The connectivity between these different networks 116, 118, 120, 122 and 124 is provided by the Internet Protocol (“IP”) and its associated set of messaging protocols. This approach enables messaging in 2G and 3G wireless networks 120 and 122 to be compatible with messaging systems found on the Internet/IP Network 124. The MMSE 114 can be implemented either within or on the periphery of a network operator's core network. In addition, network operators can support a limited set of MMS functionality, while others may require extensive and elaborate MMS support according to their business models.

The MMSE 114 encompasses all the various elements that provide a complete MMS 100 to a user. One or more Multimedia Messaging Centers (“MMC”) 126 form the core of the MMSE 114. The MMC 126 includes a multimedia service relay (“MMS Relay”) 128, a multimedia service server (“MMS Server”) 130 communicably coupled to the MMS Relay 128, a message storage device 132 communicably coupled to the MMS Server 130 and one or more databases 134 communicably coupled to the MMS Relay 128. The one or more databases 134, which may also be referred to as a customer or subscriber directory and/or an operator directory, contain one or more customized processing instructions. The MMC 126 is responsible for storage and handling of incoming and outgoing messages and for the transfer of messages between different messaging systems.

More specifically, the MMS Relay 128 and MMS Server 130 receive and send multimedia messages, enable/disable MMS functions, personalize MMS based on user profile information, delete multimedia messages based on user profile or filtering information, perform media type and format conversions, convert messages arriving at the MMSE 114 from legacy messaging systems to multimedia format (e.g. facsimile to MM), convert multimedia messages leaving the MMSE 114 to legacy messaging systems to the appropriate message format (e.g. multimedia to internet e-mail), retrieve message content, forward multimedia messages, screen multimedia messages, negotiate MMS User Agent 102-112 terminal capabilities, check MMS User Agent 102-112 terminal availability, provide multimedia message notification to the MMS User Agents 102-112, generate call data records (“CDR”), provide address translation, hide addresses, manage the message properties on servers (e.g. voice-mail or e-mail server) integrated in the MMSE 114, provide temporary and/or persistent storage of messages, ensure that messages are not lost until successfully delivered to another MMSE element, control the reply-charging feature of MMS, and other functions or services.

The MMS Relay 128 and MMS Server 130 can be separate logical elements as shown, or they can be combined into a single MMS Relay/Server element. Moreover, the MMS Relay 128 and MMS Server 130 can be distributed across different domains. If the MMS Relay 128 and MMS Server 130 are separate physical entities, the message transfer between the MMS Relay 128 and MMS Server 130 may use SMTP and POP3/IMAP or HTTP protocols. If the SMTP protocol is used to upload and download multimedia messages to the MMS Server 130, then that same protocol can be used to transfer multimedia messages between different MMSEs 114.

The MMS Relay 128 and MMS Server 130 also provide convergence functionality between external servers 138 and MMS User Agents 102, 104, 106, 108, 110 and 112 to enable the integration of different server types across different networks. The external servers 138 are communicably coupled to the MMS Relay 128 via the Internet/IP Network 124. The external servers 138 may include e-mails servers, SMS servers, fax servers, prepaid servers and multimedia content servers, which may be included within or connected to the MMSE 114.

The MMC 126 also interfaces with MMS value added service applications (“MMS VAS Applications”) 136 through the MMS Relay 128. The MMS VAS Applications 136 provide value added services to the MMS users. For example, the MMS VAS Applications 136 may provide some additional features like multimedia message recall between MMS VAS Applications 136 and the MMC 126 that are not available for MMS User Agents 102-112. MMS VAS Applications 136 can generate CDRs when receiving multimedia messages from MMC 126 and when submitting multimedia messages to MMC 126.

The one or more databases 134 may comprise one or more entities that contain user related information such as subscription and configuration (e.g. user profile, subscription, operator services, Home Location Register (“HLR”), etc.) and provide customized processing instructions. The one or more databases 134 may provide MMS user subscription information, information for the control of access to the MMS, information for the control of the extent of available service capability (e.g. server storage space), a set of rules how to handle incoming messages and their delivery, and information of the current capabilities of the user's terminal.

MMS supports the use of e-mail addresses (RFC 822) or MSISDN (E.164) or both to address the recipient of a multimedia message. MMS may support the use of service provider specific addresses to address the recipient of a multimedia message. In the case of e-mail addresses standard Internet message routing should be used. MSISDN can be used for addressing a recipient in a different MMS service provider's domain via MSISDN translation to a routable address. Service provider specific addresses may be used to deliver messages to MMS VAS Applications 136 within one MMSE 114. MMS connectivity across different networks (MMSEs) can be provided using Internet protocols. In such a case, each MMSE 114 should be assigned a unique domain name (e.g. mms.operatora.net).

MMS recipient addresses provided by a MMS User Agent 102, 104, 106, 108, 110 and 112 may be in a format of an RFC 822 routable address, such as an e-mail address, or other formats, such as E.164 or service provider specific addresses. In those cases where a non-routable address is used to specify a recipient and the recipient belongs to another MMSE 114 or the recipient is outside of any MMSE 114, the address needs to be translated to an RFC 822 routable address format. The sender's MMSE will make this mapping before routing or forwarding the message to the recipient's MMSE. The MMS service providers or network operators may use solutions for their particular needs that may include static tables or other look-up methods to map to the correct recipient's MMS Relay 128. An Electronic Numbering (“ENUM”) database can be used as the mechanism to map MSISDN numbers to RFC 822 routable addresses.

The MMS 100 can support address hiding, which allows the sender to send anonymous messages where the sender's address is not shown to the recipient MMS User Agent 102, 104, 106, 108, 110 and 112. If the peer entity is not known to be a MMSE, the originator MMSE will not provide the originator address. If the peer entity is known to be a MMSE, both the originator address and request of address hiding will be forwarded to the recipient MMSE. The recipient MMSE is responsible for not showing the originator address to the recipient MMS User Agent 102, 104, 106, 108, 110 and 112.

The MMS User Agent 102, 104, 106, 108, 110 and 112 can provide the following application layer functionalities: the multimedia message presentation; the presentation of notifications to the user; and the retrieval of multimedia messages (initiate multimedia message delivery to the MMS User Agent 102, 104, 106, 108, 110 and 112). The MMS User Agent 102, 104, 106, 108, 110 and 112 may provide additional application layer functionalities such as: multimedia message composition; multimedia message submission; signing of a multimedia message on an end-user to end-user basis; decryption and encryption of a multimedia message on an end-user to end-user basis; all aspects of storing multimedia messages on the terminal and/or USIM; handling external devices; and user profile management.

The MMS 100 will support the ability to create, update, store, transfer, interrogate, manage and retrieve a user's multimedia messaging profiles. The multimedia messaging profiles will allow a user to configure and personalize his or her multimedia messaging environment (e.g., which media types and notifications that will be delivered to the recipient, such as voice only or text only). The multimedia messaging profiles will form part of the user's virtual home environment.

The user will be able to use and access multimedia messages in a secure manner. The contents of multimedia messages can be read only by the intended recipient(s). A recipient will be informed of the reliability of the identity of the sender in case the sender has authorized his identity to be transmitted. The integrity of multimedia messages during transit will be assured to extent of the network capabilities. In addition, the MMS 100 will be intrinsically resistant to attempts of malicious or fraudulent use.

The MMS 100 will also support various charging mechanisms. The following characteristics can be used as charging mechanisms: message type, length, storage time in the network, etc.; delivering time, upload/download method; multimedia message sender/recipient; number of messages sent; number of messages received; roaming conditions; location conditions; pre-charging notification; and prepaid subscriptions. The pre-charging notification indicates to the recipient prior to the recipient downloading a multimedia message whether the sender has paid for the message or the recipient is expected to pay for the message.

Multiple media elements can combine into a composite single multimedia message using MIME multipart format as defined in RFC 2046. The media type of a single multimedia message element can be identified by its appropriate MIME type whereas the media format can be indicated by its appropriate MIME subtype. The MMS User Agents 102, 104, 106, 108, 110 and 112 can support media formats or codecs for supporting media types, such as Text (plain text; character encoding (charset) containing a subset of the logical characters in Unicode (e.g. US-ASCII, ISO-8859-1, UTF-8, Shift_JIS, etc.)), Audio (AMR; organized in the Bitstream Syntax as proposed by the IETF; MP3; MIDI; WAV), Image (Baseline JPEG; MP4; GIF 89a), and Video (MPEG 4 (Visual Simple Profile, Level 1); ITU-T H.263; Quicktime). Other formats or standards can be used.

The present invention also offers many services. For example, when a user intends to send a multimedia message to one or several destinations, the multimedia message is submitted to the originator MMS Relay 128/MMS Server 130. Note that submission of multimedia messages is optional for MMS User Agents 102, 104, 106, 108, 110 and 112. If a MMS User Agent 102, 104, 106, 108, 110 and 112 supports submission of multimedia messages, the MMS User Agent 102, 104, 106, 108, 110 and 112 should: indicate the address of the multimedia message recipient; and identify the MIME content type of the message. The MMS User Agent 102, 104, 106, 108, 110 and 112 may also: request a delivery report for the message; request a read-reply report for the message; provide a time stamp for the time of submission of the message; set the earliest desired expiration time or period for the message; set the desired expiration time or period for the message; indicate the address of the multimedia message originator; set further message qualifications (e.g. priority, message class, subject); and request that the multimedia message originator's address be hidden from the recipient MMS User Agent 102, 104, 106, 108, 110 and 112. Upon reception of a multimedia message from an originator MMS User Agent 102, 104, 106, 108, 110 and 112, the originator MMSE: will assign a Message Identification to the multimedia message and provide the originator MMS User Agent 102, 104, 106, 108, 110 and 112 with this Message Identification; is responsible for retaining the multimedia message until the earliest desired time of delivery, if the optional feature of earliest time of delivery is supported by the originator MMSE (if this feature is not supported, then the multimedia message is immediately routed forward); may provide a time stamp, i.e. it may also override the MMS User Agent's time stamp; will insert the originator's address into the multimedia message if not yet provided by the originator MMS User Agent 102, 104, 106, 108, 110 and 112; will pass the originator's address to the peer entity if the peer entity is known to be a MMSE; will route forward the request for address hiding unaltered to the recipient MMSE if the peer entity is known to be an MMSE; will pass the originator's address to the peer entity if the peer entity is not known to be an MMSE and address hiding has not been requested by the originator MMS User Agent 102, 104, 106, 108, 110 and 112; will not pass the originator's address to the peer entity and should override the address provided by the originator MMS User Agent 102, 104, 106, 108, 110 and 112 in the multimedia message to an “anonymous” address if the peer entity is not known to be an MMSE and address hiding has been requested by the originator MMS User Agent 102, 104, 106, 108, 110 and 112; may override the address provided by the originator MMS User Agent in the multimedia message (subject to MMS service provider's preferences); is responsible for resolving the multimedia message recipient's address(es); is responsible to route the multimedia message towards the multimedia message recipients; should pass the indication whether or not a delivery report is requested unaltered when routing the multimedia message towards the multimedia message recipient(s); will pass the indication whether or not a read-reply report is requested unaltered when routing the multimedia message towards the multimedia message recipient(s); will pass the indication about MIME content type of the message and message qualifications (e.g. priority, message class, subject) unaltered when routing the multimedia message towards the multimedia message recipient(s); and will generate a delivery report indicating “indeterminate” status of the multimedia message's delivery if a delivery report was requested by the originator MMS User Agent 102, 104, 106, 108, 110 and 112 and if the peer entity the multimedia message is routed forward to is not known by the originator MMC. A special case is where the recipient MMSE is also the originator MMSE. In this case the multimedia message does not have to be routed forward.

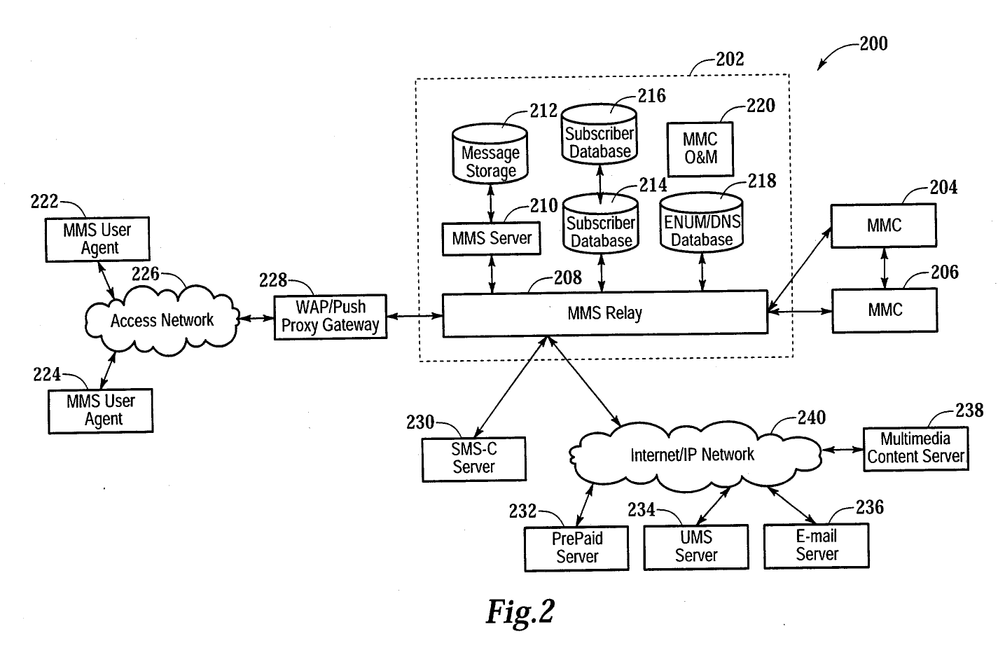

Now turning to FIG. 2, an architectural overview of a MMS 200 in accordance with another embodiment of the present invention is shown. MMC 202, MMC 204 and MMC 206 are all communicably coupled to each other. MMC 202, MMC 204 and MMC 206 may be operated by the same network operator or by different network operators. MMC 202 comprises a MMS Relay 208, MMS Server 210, message storage 212, subscriber database 214, operator services database 216, ENUM/Domain Name System (“DNS”) database 218 and a MMC O&M 220. MMS Relay 208 is communicably coupled to a MMS Server 210, a subscriber database 214 and the ENUM/DNS database 218. The MMS Server 210 is communicably coupled to the message storage 212, and the subscriber database 214 is communicably coupled to the operator services database 216. Note that the subscriber database 214 and operator services database 216, which were collectively referred to as the one or more databases 124 in FIG. 1, can both be directly coupled to the MMS Relay 208.

MMS User Agents 222 and 224 are communicably coupled to the MMS Relay 208 via an access network 226 and a WAP/Push Proxy Gateway 228. The WAP/Push Proxy Gateway 228 can be separated into two separate logical entities. A SMS-C Server 230 is also communicably coupled to the MMS Relay 208. Prepaid Server 232, Unified Messaging System (“UMS”) Server 234, E-mail Server 236 and Multimedia Content Server 238 are communicably coupled to the MMS Relay 208 via Internet/IP Network 240.

Depending on the SMS-C Server 230 manufacturer, the MMS Relay 208 either can be directly connected to the SMS-C Server 230 or an additional SMS-Gateway (not shown) can be added. In the latter case, the SMS-Gateway (not shown) is located between the MMS Relay 208 and the SMS-C Server 230 and provides the mapping of one or several SMSC access protocol (mapping between MMS Relay 208 SMSC access protocol and operator's existing SMSC access protocol).

The Prepaid Server 232 supports the prepaid concept within the MMSE. A prepaid customer may be charged for submitting or retrieving multimedia/abstract messages. In the submission case, the originator MMC 202 will first ascertain that the originator of the multimedia/abstract message is a prepaid customer. The MMC 202 then initiates a credit check and further processing of the multimedia/abstract message is put on hold. In the case where the customer's credit is insufficient to submit this particular multimedia/abstract message, the originator MMC 202 may reject it. The credit check may be based on several criteria like: size of the multimedia message; content type; settings of information elements; and type of the abstract message. In the case where multimedia/abstract message cannot be accepted, the originator MMC 202 will respond with an appropriate status value to the submitted request. The MMS User Agent 222 and 224 should bring this information to the user's attention. In the case where multimedia/abstract message is accepted, the message is further processed by the MMC 202.

In the retrieving case, the recipient MMC 202 will first ascertain that the recipient of the multimedia/abstract message is a prepaid customer. The MMC 202 then initiates a credit check for the particular customer. The credit check can be performed at the time the multimedia/abstract message arrives at the recipient MMC 202. Based on the results of the credit check, the MMC 202 will reject or accept the multimedia/abstract message. If the multimedia/abstract message is accepted (with or without the previous credit check), the MMC 202 may perform a credit check at the time the MMS User Agent 222 and 224 sends a retrieve request. The credit check may be based on several criteria as in the sending case previously described. In the case where a multimedia/abstract message can not be retrieved because the customer's account balance is too low, the recipient MMC 202 may respond with an appropriate status value to the retrieve request. The MMS User Agent 222 and 224 should bring this information to the user's attention. Otherwise the multimedia/abstract message will be delivered to the MMS User Agent 222 and 224.

Many carriers are operating or planning to operate UMS platforms, as well as conform to 3GPP specifications. As a result, newly deployed UMS platforms will use MMS 200 as their wireless access User Agents. However, newly deployed MMS systems will likely co-exist and integrate with UMS, voice mail systems (“VMS”), and e-mail systems. In addition, UMS will likely involve other access methods, such as PC mail access, Web browser access, PSTN, voice phone access, etc.

Some operators may choose to integrate their MMS and UMS services. Even with a complete migration strategy, large e-mail systems and VMS systems will likely require lengthy migration periods during which an integrated operation between the 3GPP and legacy systems must occur. Also, some installations will require permanent integrations, where 3GPP systems continuously interoperate with a legacy UMS or a legacy VMS. As shown, the MMC 202 interoperates with a UMS Server 234 that connects to VMS, SMS, fax, and e-mail. The MMC 202 can, therefore, obtain e-mail, voice, and/or fax messages from the UMS Server 234. PC clients may also be accessed through the UMS Servers 234, which may be integrated with the MMS Servers 234 by some operators. In this case a unified mailbox will be presented to both MMS users and others who access the system via other devices.

In addition, the UMS Server 234 can stream compressed voice from the VMS, assuming that streaming support is available in the servers as well as the clients. It could also establish a CS connection (using for example WTA methods to the wireless terminal). Voice mail and faxes can also originate from a voice/fax gateway server, which exists in both the legacy VMS as well as a UMS. Faxes can be sent out to remote fax numbers via the fax gateway. In that case, the gateway would convert the voice mail or Fax to Voice Profile for Internet Mail (“VPIM”) based e-mail messages. Access to the VMS and UMS should occur via open standard protocols, such as Post Office Protocol Version 3 (“POP3”), Internet Message Access Protocol (“IMAP4”, WebDAV, T.30, H.323, etc.).

With respect to the transfer of facsimile data via store-and-forward mechanisms, the MMC 202 will interface with a T.37 Fax Gateway (not shown) using the appropriate SMTP protocol. The Fax Gateway (not shown) will terminate the T.30 protocol towards a Public Switched Telephone Network (“PSTN”). Mobile terminated fax data will be converted into TIFF image format and forwarded to the MMC 202 as an attachment in an Internet Engineering Task Force (“IETF”) internet e-mail. In the case of mobile originated fax messages, the Fax Gateway (not shown) receives a written e-mail provided with the receiver's fax number from the MMC 202. Depending on the functions of the Fax Gateway (not shown), this e-mail may contain plain text only or additional attachments. Although T.37 requires only TIFF format support, the Fax Gateways (not shown) may permit many different formats.

MMS 200 interaction with voice mailbox systems should be performed on a non-real time basis. The Voice Profile for Internet Mail Version 2, VPIMv2, provides format extensions for MIME supporting the transmission of voice messages over standard Internet e-mail systems. The VPIM concept was developed by the Electronic Messaging Association (“EMA”). After VPIMv2 had been reviewed by the IETF it became RFC 2421. The VPIM specification allows voice records to be MIME encapsulated and sent as Internet mail attachments via Simple Mail Transfer Protocol (“SMTP”) or retrieved as Internet mail attachments via POP3 or IMAP4. The MIME type used for voice messages is “audio/*”. For the interaction of MMS 200 with voice mailboxes, the voice mailbox may forward received voice records as VPIM messages via SMTP to the MMC 202. In this case, the protocol to be used on the interface between MMC 202 and the voice mailbox is SMTP and is, therefore, identical to the one used between different MMCs. Alternatively, the MMC 202 may poll the voice mailbox via POP3 or IMAP4 for newly received messages. Messages that the user wants to retrieve via the MMS service can then be downloaded via POP3/IMAP4 from the voice mailbox to the MMC 202 from where they are delivered to the MMS User Agent 222 or 224. This enables the user to do both, retrieve voice messages via today's real time voice mail services or as a multimedia message. In any case, it is expected that the voice mailbox is still the owner of the message and as a consequence is responsible for the storage. As an alternative, the MMS 200 interworking with a 2G/3G Voice Mailbox System could be envisaged via an Hypertext Transfer Protocol (“HTTP”) interface.

The E-Mail Server 236 provides post office services that are accessible via POP3 or IMAP for Internet e-mail retrieval in the MMS 200 or are accessible to the MMC 202 using SMTP. The MMC 202 sends messages that are to be transmitted as Internet e-mail via SMTP. The retrieval and sending of multimedia messages from and to the Internet e-mail service is done via SMTP. The protocol used on the interface between MMC 202 and the Mail Transfer Agent, MTA/E-mail Server is identical to the one used between different MMS Relays 210.

WAP provides significant support for MMS 200, both in direct service specification and in the underlying technologies. WAP support for MMS 200 is based upon the services of its supporting technology. The first communication link, between the wireless MMS User Agent 222 and 224 and the WAP Gateway 228, is where the “WAP Stack” is used to provide a common set of services over a variety of wireless bearers. For application-oriented services, like MMS 200, the interest is primarily in services offered by WAP Session Protocol (“WSP”). The second communication link connects the WAP Gateway 228 and the MMS Relay 208. In the WAP architecture, the MMS Relay 208 is considered an Origin Server. These entities are connected over an IP network such as the Internet or a local Intranet. HTTP is used for data transfer and data can be originated from either entity. End-to-end connectivity, for the MMS application, between the wireless MMS User Agent 222 and 224 and the MMS Relay 208 is accomplished by sending data over WSP and HTTP. This is accomplished using the WSP/HTTP POST method for data originating at the wireless MMS User Agent 222 and 224 and by using the WAP Push Access Protocol in the other direction. The WAP Gateway 228, which enables the needed interworking, should not modify the data transfer via these transactions. The WAP view of MMS 200 is constrained to the interactions between the MMS User Agent 222 and 224 and the MMC 202.

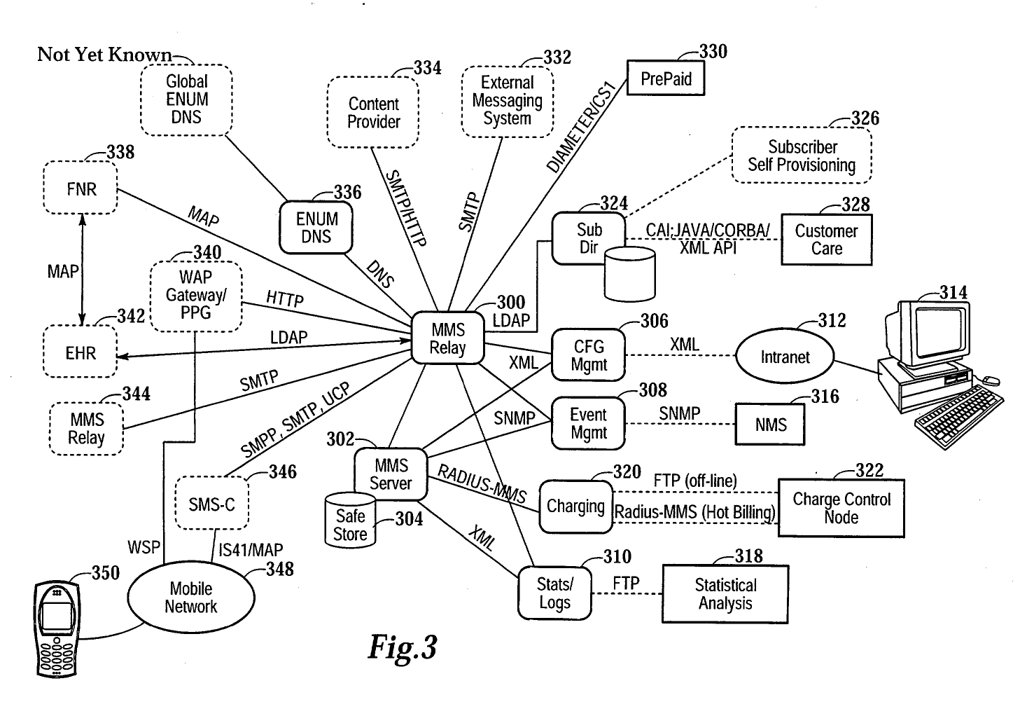

Referring now to FIG. 3, a block diagram of a logical MMS platform in accordance with one embodiment of the present invention is shown. MMS Relay 300 is communicably coupled to MMS Server 302, which has a safe storage 304. MMS Relay 300 and MMS Server 302 are communicably coupled to a CFG Manager 306 using XML, an event manager 308 using SNMP, and a Stats/Logs 310 using XML. The CFG Manager 306 is communicably coupled to one or more user terminals 312 via an Intranet 314 using XML. The event manager 308 is communicably coupled to a NMS 316 using SNMP. The Stats/Logs 310 is communicably coupled to a statistical analysis program 318 using File Transfer Protocol (“FTP”). The MMS Server 302 is also communicably coupled to a charging function 320 using Radius-MMS, which is in turn communicably coupled to a charge control node 322 using FTP for off-line processing and Radius-MMS for hot billing.

The MMS Relay 300 is communicably coupled to a subscriber directory 324 using LDAP, which is in turn communicably coupled to a subscriber self provisioning function 326 and customer care function 328 using CAI, Java/CORBA, or XML APIs. The MMS Relay 300 is also communicably coupled to a prepaid server 330 using DIAMETER/CSI, an external messaging system 332 using SMTP and a content provider server 334 using SMTP/HTTP. In addition, the MMS Relay 300 is communicably coupled to a ENUM/DNS database 336 using DNS, a FNR 338 using MAP, a WAP Gateway/PPG 340 using HTTP, an ERH 342 using LDAP, other MMS Relays 344 using SMTP and a SMS-C Server 346 using SMPP, SMTP or UCP. The ENUM/DNS database 336 is communicably coupled to a global ENUM/DNS database 348. The FNR 338 and ERH 342 are communicably coupled using MAP. The WAP Gateway/PPG 340 is communicably coupled to a mobile network 348 using WSP. The SMS-C Server 346 is communicably coupled to the mobile network 348 using IS41/MAP. One or more mobile terminals 350 are communicably coupled to the mobile network 348.

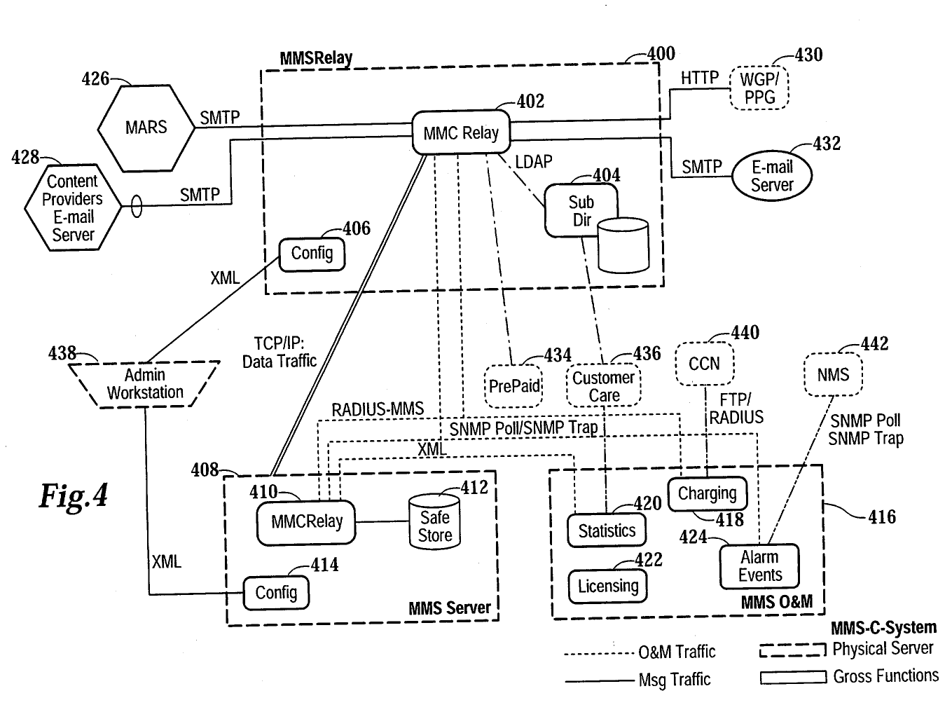

Turning now to FIG. 4, a block diagram of a MMC in accordance with one embodiment of the present invention is shown. The physical server representing the MMS Relay 400 provides a MMC Relay function 402, a subscriber directory function 404 and configuration function 406. The physical server representing the MMS Server 408 provides a MMC Server function 410, a safe storage function 412 and a configuration function 414. The physical server representing the MMS O&M 416 provides a charging function 418, a statistics function 420, a licensing function 422 and an alarm events function 424. TCP/IP data traffic is passed between the MMC Relay 402 function and the MMC Server function 410.

Message traffic is passed between the MMC Relay function 402 and MARS 426 via SMTP, Content Providers E-mail Server 428 via SMTP, WFP/PPG 430 via HTTP and E-mail Server 432 via SMTP. O&M traffic is passed between the MMC Relay function 402 and the MMC Server function 410 via SNMP Poll/SNMP Trap and XML, the statistics function 420 via XML, the alarm events 424 via SNMP Poll/SNMP Trap, the prepaid server 434, and the subscriber directory 404 via LDAP. In addition, O&M traffic is passed between the subscriber directory 404 and the customer care 436. Message traffic is passed between the configuration function 406 and the administration workstation 438 via XML.

Within the MMS Server 408, message traffic is passed between the MMC Server function 410 and the safe storage 412. O&M traffic is passed between the MMC Server function 410 and the MMC Relay function 402 via SNMP Poll/SNMP Trap and XML, the statistics function 420 via XML, the charging function 418 via RADIUS-MMS and the alarm events 424 via SNMP Poll/SNMP Trap. Message traffic is passed between the configuration function 414 and the administration workstation 438 via XML. Within the MMS O&M 416, O&M traffic is passed between the statistics function 420 and the customer care 436; the charging function 418 and the CCN 440 via FTP/RADIUS; and the alarm events 424 and the NMS 442 via SNMP Poll/SNMP Trap.

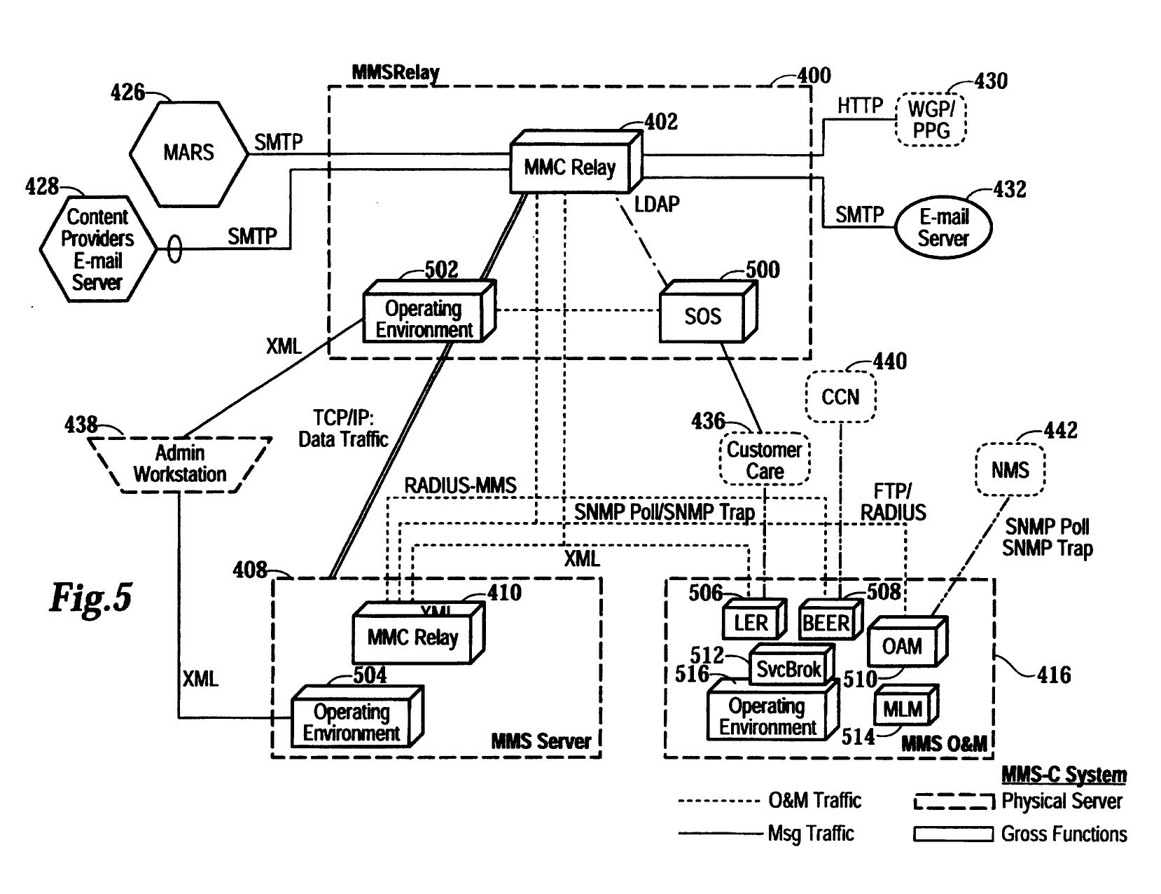

Now referring to FIG. 5, a block diagram showing the components of a MMC in accordance with one embodiment of the present invention is shown. The physical server representing the MMS Relay 400 provides a MMC Relay function 402, a SOS 500 and an operating environment 502. The physical server representing the MMS Server 408 provides a MMC Server function 410 and an operating environment 504. The physical server representing the MMS O&M 416 provides a LER 506, BEER 508, OAM 510, SvcBrok 512, MLM 514 and an operating environment 516. TCP/IP data traffic is passed between the MMC Relay 402 and the MMC Server 410.

Message traffic is passed between the MMC Relay function 402 and MARS 426 via SMTP, Content Providers E-mail Server 428 via SMTP, WFP/PPG 430 via HTTP and E-mail Server 432 via SMTP. O&M traffic is passed between the MMC Relay function 402 and the MMC Server function 410 via SNMP Poll/SNMP Trap and XML, the LER 506 via XML, and the OAM 510 via SNMP Poll/SNMP Trap. In addition, O&M traffic is passed between the SOS 500 and the customer care 436 and operating system 502. Message traffic is passed between the operating environment 502 and the administration workstation 438 via XML.

Within the MMS Server 408, O&M traffic is passed between the MMC Sever function 410 and the MMC Relay function 402 via SNMP Poll/SNMP Trap and XML, the LER 506, the BEER 508 via RADIUS-MMS and OAM 510 via SNMP Poll/SNMP Trap. Message traffic is passed between the operating environment 504 and the administration workstation 438 via XML. Within the MMS O&M 416, O&M traffic is passed between the LER 506 and the customer care 436; the BEER 508 and the CCN 440 via FTP/RADIUS; and the OAM 510 and the NMS 442 via SNMP Poll/SNMP Trap.

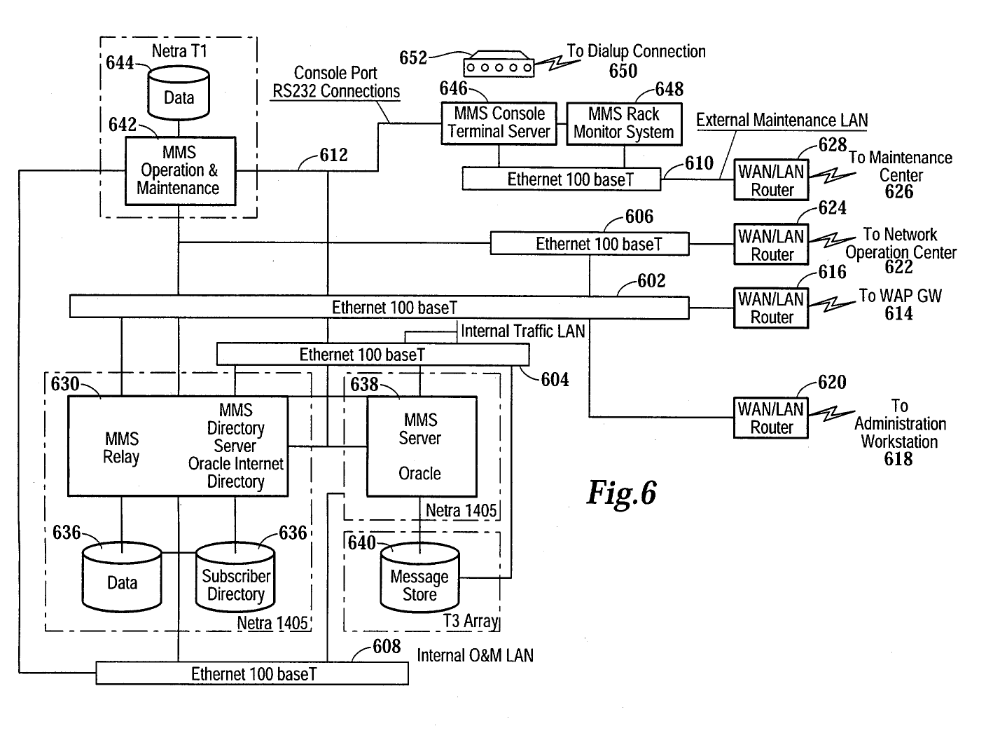

FIG. 6 is a block diagram showing the network connectivity of a MMC in accordance with one embodiment of the present invention. The MMC has an external traffic LAN 602, an internal traffic LAN 604, a primary O&M LAN 606, an internal O&M LAN 608, an external maintenance LAN 610 and console port RS232 connections 612. A WAP Gateway 614 is communicably coupled to the external traffic LAN 602 via a WAN/LAN router 616. An administration workstation 618 is communicably coupled to the primary O&M LAN 606 via a WAN/LAN router 620. A network operation center 622 is communicably coupled to the primary O&M LAN 606 via a WAN/LAN router 624. A maintenance center 626 is communicably coupled to the external maintenance LAN 610 via a WAN/LAN router 628.

The MMS Relay 630 is connected to the external traffic LAN 602 and to a database 632. The MMS Directory Server 634 is connected to the internal traffic LAN 604, the console port RS232 connections 612 and the subscriber directory 636. The MMS Server 638 is connected to the internal traffic LAN 604, the console port RS232 connections 612 and the message storage 640. The message storage 640 is connected to the MMS Server 638 and the internal traffic LAN 604. The MMS O&M 642 is connected to the MMS Relay 630/MMS Directory Server 634 via primary O&M LAN 606 and internal O&M LAN 608. The MMS O&M 642 is also connected to a database 644. Moreover, MMS O&M 642 is connected to the MMS Server 638 via internal O&M LAN 608 and console port RS232 connections 612; and to MMS Relay 630/MMS Directory Server 634 via console port RS232 connections 612; and to MMS Console Terminal Server 646 and MMS Rack Monitor System 648 via console port RS232 connections 612. MMS Console Terminal Server 646 is communicably coupled to a dialup connection 650 via modem 652.

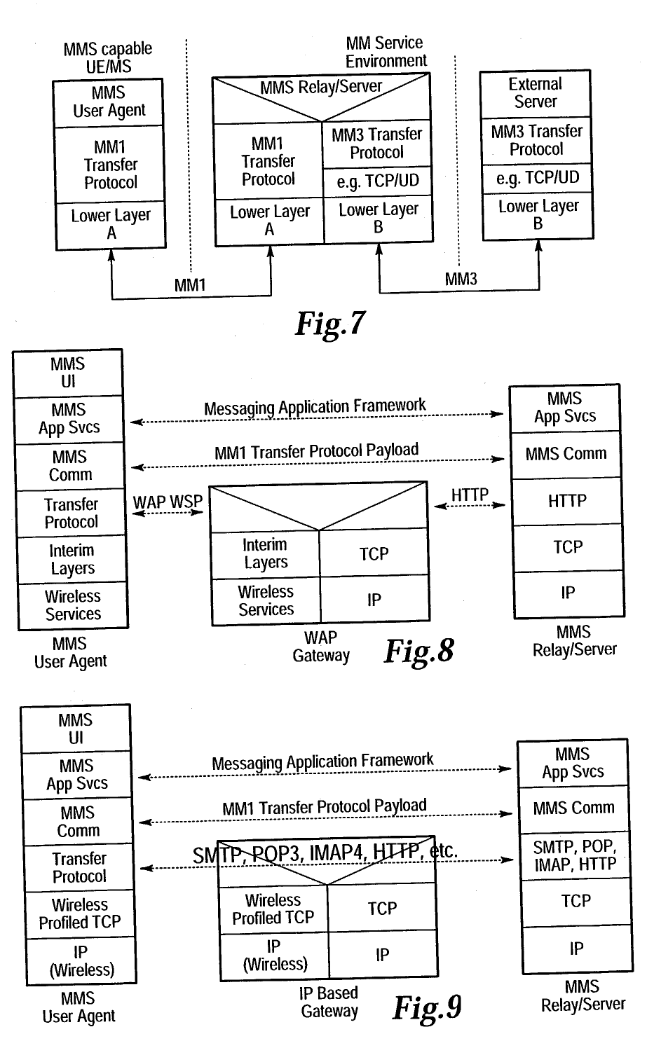

Now referring to FIG. 7, a block diagram showing a protocol framework of the MMS User Agent, MMC and External Servers in accordance with one embodiment of the present invention is shown. Similarly, FIG. 8 depicts a block diagram showing a protocol framework of the MMS User Agent, WAP Gateway and MMC in accordance with one embodiment of the present invention. FIG. 9 is a block diagram showing a protocol framework of the MMS User Agent, IP Based Gateway and MMC in accordance with one embodiment of the present invention.

Referring now to FIG. 10, a block diagram showing the communication between two MMSEs 1002 and 1012 in accordance with one embodiment of the present invention is shown. MMSE 1002 is operated by service provider A and contains MMC 1004 and radio network 1006, which are communicably coupled together. MMS User Agent 1008 is communicably coupled to radio network 1006. MMSE 1012 is operated by service provider B and contains MMC 1014 and radio network 1016, which are communicably coupled together. MMS User Agent 1018 is communicably coupled to radio network 1016. MMC 1004 and MMC 1014 are communicably coupled together.

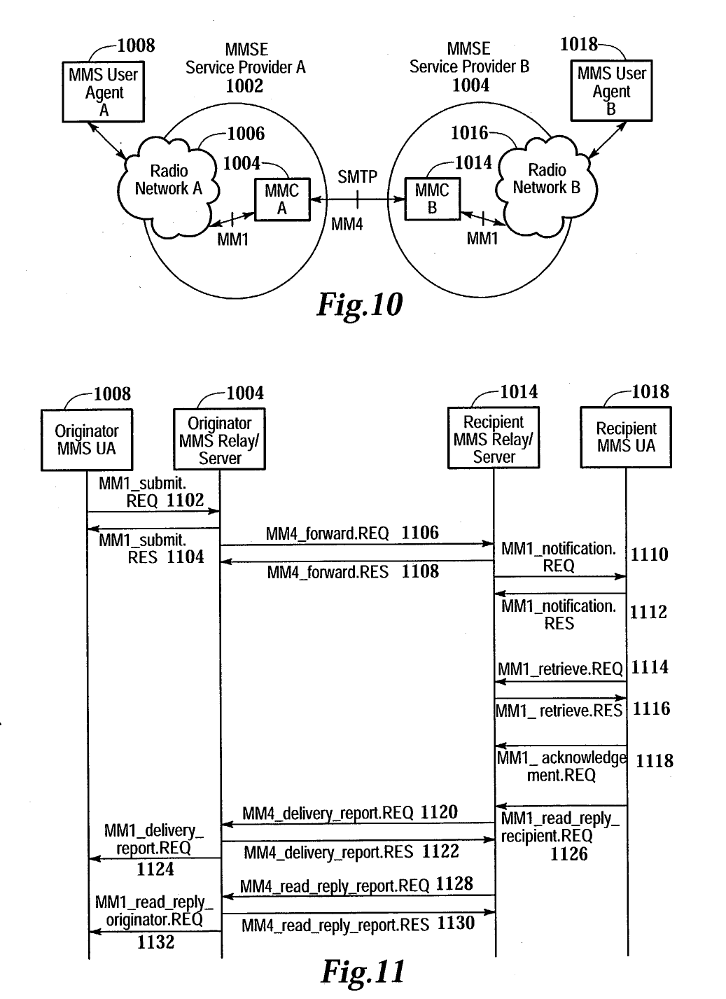

Now referring to FIG. 11, a message flow diagram showing the communication between two MMSEs 1002 and 1012 in accordance with one embodiment of the present invention is depicted. The MMS abstract messages used in this example follow the these conventions: the transactions between the MMS User Agent 1008 and 1018 and MMS Relay/Server 1004 and 1014 are prefixed with “MM1”; the transactions between the MMS Relay/Servers 1004 and 1014 are prefixed with “MM4”; requests are identified with “.REQ” as a suffix; and responses are identified with the “.RES” suffix. Each abstract message carries with it certain information elements, which may vary according to the specific message. All messages will carry, as information elements, a protocol version and message type, in order that the MMSE components may be able to properly identify and manage the message contents. Specific information regarding the message encapsulation, including order, possible values, and encoding are not described because they will vary according the MMSE protocol environment. Depending on the MMS Implementation (WAP etc.), one or more abstract messages may be mapped to a single lower layer PDU, and a single abstract message may be mapped to multiple lower layer PDUs, if the information carried in the PDU(s) serve the purpose of required information in the subjected abstract message(s). In MM1 responses that provide a status information, the status information returned has no correspondence to the status information returned in MM4 responses; they are independent of each other. The MM1 response status, which are limited by design to as small a set of values as possible, may correlate to status and errors occurring within the communications protocols underlying the implementation of the MM4 abstract messages. Similarly, the MM4 status may correlate to those occurring within the communications protocols underlying the implementation of the MM1 abstract messages. The MMS application protocol will provide means to uniquely identify the version number and message type in each abstract message defined here. The order, possible values and encoding of the information elements for each abstract message will be dictated by the protocol environment. Note that delivery reports are sent by the recipient MMS Relay/Server 1014 and read-reply reports are sent by the recipient MMS User Agent 1018.

Submission of Multimedia Message MM1—This part of MMS service covers the submission of a multimedia message. For sending purposes, a terminal-originated multimedia message will always be submitted from the originator MMS User Agent 1008 to the corresponding MMS Relay/Server 1004. Involved abstract messages are outlined in Table 1 from type and direction points of view.

TABLE 1
Abstract messages for submission of multimedia message in MMS

| Abstract messages | Type | Direction |
|---|---|---|
| MM1_submit.REQ 1102 | Request | MMS UA 1008 −> MMS |
| | | Relay/Server 1004 |
| MM1_submit.RES 1104 | Response | MMS Relay/Server 1004 −> MMS |
| | | UA 1008 |

During normal operation, the originator MMS User Agent 1008 will submit a terminal-originated multimedia message to the originator MMS Relay/Server 1004 using the MM1_submit.REQ 1102, which contains MMS control information and the multimedia message content. The MMS Relay/Server 1004 will respond with a MM1_submit.RES 1104, which provides the status of the request. The MM1_submit.RES 1104 will unambiguously refer to the corresponding MM1_submit.REQ 1102. Support for MM1_submit.REQ 1102 is optional for the MMS UA 1008, support for MM1_submit.RES 1104 is mandatory for the MMS Relay/Server 1004. Such a process may be implemented with, for example, reference to 3GPP standard 23.140 and WAP standard WAP-209.

During abnormal operation, the originator MMS Relay/Server 1008 will respond with a MM1_submit.RES 1104 encapsulating a status, which indicates the reason the multimedia message was not accepted, e.g. no subscription, corrupt message structure, service not available. If the MMS Relay/Server 1008 does not provide the MM1_submit.RES 1104, the MMS User Agent 1008 should be able to recover.

One or several multimedia message recipients of a submitted multimedia message will be indicated in the addressing-relevant information field(s) of the MM1_submit.REQ 1102. The originator of a submitted multimedia message may be indicated in addressing-relevant information field(s) of the MM1_submit.REQ 1102. The originator MMS User Agent 1008 may request to hide its identity from the multimedia message recipient. The originator MMS User Agent 1008 may time stamp the multimedia message. The originator MMS User Agent 1008 may also request an earliest desired time of delivery of the multimedia message. The originator MMS User Agent 1008 may request an expiration period or time for the multimedia message. In the case of reply-charging, the originator MMS User Agent 1008 may also request a deadline for the latest time of submission of multimedia message reply granted to the recipient(s). The originator MMS User Agent 1008 may indicate that the sender wants to pay for a multimedia message reply in the MM1_submit.REQ 1102. The multimedia message may be qualified further by adding a message class, priority and/or subject to the multimedia message in the MM1_submit.REQ 1102. Additional qualifiers may also be added. The originator MMS User Agent 1008 may request a delivery report for the multimedia message. In addition, the originator MMS User Agent 1008 may request a read-reply report when the user has viewed the multimedia message. The originator MMS Relay/Server 1004 will always provide a message identification for a multimedia message, which it has accepted for submission in the MM1_submit.RES 1104. In the case of reply-charging, the MMS User Agent 1018, which submits a multimedia message reply (i.e. the MMS User Agent that received the original multimedia message), will provide the message-ID of the original multimedia message, which it replies to in the MM1_submit.REQ 1102. The MIME type of the multimedia content will always be identified in the MM1_submit.REQ 1102. The originator MMS User Agent 1008 may add content in the MM1_submit.REQ 1102. The originator MMS Relay/Server 1004 will indicate the status of the MM1_submit.REQ 1102 in the associated MM1_submit.RES 1104. The reason code given in the status information element of the MM1_submit.RES 1102 may be supported with an explanatory text further qualifying the status. If this text is available in the status text information element the MMS User Agent 1008 should bring it to the user's attention. The choice of the language used in the status text information element is at the discretion of the MMS service provider.

TABLE 2
Information elements in the MM1_submit.REQ. 1102,
as defined in WAP-209 and 3GPP 23.140

| Information element | Presence | Description |
|---|---|---|
| Recipient address | Mandatory | The address of the recipient MMS User Agent |
| | | 1018. Multiple addresses are possible. |
| Content type | Mandatory | The content type of the multimedia message's |
| | | content. |
| Sender address | Optional | The address of the multimedia message |
| | | originator. |
| Message class | Optional | The class of the multimedia message(e.g., |
| | | personal, advertisement, information service) |
| Date and time | Optional | The time and date of the submission of the |
| | | multimedia message(time stamp). |
| Time of Expiry | Optional | The desired time of expiry for the multimedia |
| | | message or multimedia message reply. |
| Earliest delivery time | Optional | The earliest desired time of delivery of the |
| | | multimedia message to the recipient. |
| Delivery report | Optional | A request for delivery report. |
| Reply-Charging | Optional | A request for reply-charging. |
| Reply-Deadline | Optional | In case of reply-charging the latest time of |
| | | submission of replies granted to the recipient(s). |
| Priority | Optional | The priority (importance) of the message. |
| Sender visibility | Optional | A request to show or hide the sender's identity |
| | | when the message is delivered to the recipient. |
| Read reply | Optional | A request for read reply report. |
| Subject | Optional | The title of the whole multimedia message. |
| Reply-Charging-ID | Optional | In case of reply-charging when the multimedia |
| | | message reply is submitted within the |
| | | MM1_submit.REQ 1102 this is the identification |
| | | of the original multimedia message that is replied |
| | | to. |
| Content | Optional | The content of the multimedia message |

TABLE 3
Information elements in the MM1_submit.RES. 1104

| Information element | Presence | Description |
|---|---|---|
| Request Status | Mandatory | The status of the multimedia message |
| | | submit request. |
| Request Status Text | Optional | Description which qualifies the status of |
| | | the multimedia message submit request. |
| Message ID | Mandatory | The identification of the multimedia |
| | | message given to an accepted |
| | | multimedia message. |

Multimedia Message Notification—This part of the MMS service covers the notification about multimedia message from the recipient MMS Relay/Server 1014 to the corresponding recipient MMS User Agent 1018 and involving abstract messages are outlined in Table 4 from type, and direction points of view.

TABLE 4
Abstract messages for notification of multimedia message in MMS

| Abstract message | Type | Direction |
|---|---|---|
| MM1_notification.REQ 1110 | Request | MMS Relay/Server 1014 −> MMS UA 1018 |
| MM1_notification.RES 1112 | Response | MMS UA 1018 −> MMS Relay/Server 1014 |

During normal operation and upon receiving the MM1_notification.REQ 1110, the recipient MMS User Agent 1018 will respond with the MM1_notification.RES 1112 to the recipient MMS Relay/Server 1014 to acknowledge the successful reception of the MM1_notification.REQ 1110. The MM1_notification.RES 1112 will unambiguously refer to the corresponding MM1_notification.REQ 1110.

During abnormal operation, the recipient MMS UA 1018 will respond with a MM1_notification.RES 1112 encapsulating a status which indicates the reason the notification could not be processed. If the recipient MMS UA 1018 does not provide the MM1_notification.RES 1112, the recipient MMS Relay/Server 1014 should be able to retransmit the notification at a later state.

The multimedia message originator address may be provided to recipient MMS User Agent 1018 in the MM1_notification.REQ 1110. The recipient MMS User Agent 1018 will be provided an expiration period or time for the multimedia message. In case of reply-charging, the deadline for the latest time of submission of a multimedia message reply should be conveyed within the MM1_notification.REQ 1110. In case of reply-charging, the recipient MMS Relay/Server 1014 may indicate in the MM1_notification.REQ 1110 that a reply to the notified original multimedia message is free of charge. The multimedia message will be qualified further by adding a message class and an approximate size to the multimedia message in the MM1_notification.REQ 1110. The multimedia message may be qualified further by adding a subject to the multimedia message. Additional qualifiers may also be added. If the originator MMS User Agent 1008 has requested to have a delivery report, the recipient MMS Relay/Server 1014 may convey this information to the recipient MMS User Agent 1018 in the MM1_notification.REQ 1110. The recipient MMS User Agent 1018 may indicate in the MM1_notification.RES 1112 that it does not want a delivery report to be created. In the case of reply-charging when a multimedia message reply is notified within the MM1_notification.REQ 1110 the recipient MMS Relay/Server 1014 should convey the identification of the original multimedia message replied to within the same MM1_notification.REQ 1110. The recipient MMS Relay/Server 1014 will always provide a reference, e.g., URI, for the multimedia message in the MM1_notification.REQ 1110. The recipient MMS User Agent/1018 may indicate in the MM1_notification.RES 1112 how it intends the multimedia message to be handled, e.g. the immediate rejection of the multimedia message.

TABLE 5
Information elements in the MM1_notification.REQ 1110,
as defined in WAP-209 and 3GPP 23.140.

| Information element | Presence | Description |
|---|---|---|
| Message class | Mandatory | The class of the multimedia message(e.g., |
| | | personal, advertisement, information service; |
| | | default = personal) |
| Message size | Mandatory | The approximate size of the multimedia message. |
| Time of expiry | Mandatory | The time of expiry for the multimedia message. |
| Message Reference | Mandatory | A reference, e.g., URI, for the multimedia |
| | | message. |
| Subject | Optional | The title of the whole multimedia message. |
| Sender address | Optional | The address of the multimedia message originator. |
| Delivery report | Optional | Request for delivery report. |
| Reply-Charging | Optional | Information that a reply to this particular original |
| | | multimedia message is free of charge. |
| Reply-Deadline | Optional | In case of reply-charging the latest time of |
| | | submission of a reply granted to the recipient. |
| Reply-Charging-ID | Optional | The identification of the original multimedia |
| | | message replied to if this notification indicates a |
| | | multimedia message reply. |

TABLE 6
Information elements in the MM1_notification.RES 1112.

| Information element | Presence | Description |
|---|---|---|
| Multimedia | Optional | The status of the multimedia message's |
| Message Status | | retrieval. |
| Report allowed | Optional | Request to allow or disallow the |
| | | sending of a delivery report to the |
| | | multimedia message originator. |

Retrieval of Multimedia Message—This part of MMS service covers the retrieval of a multimedia message. For retrieval purposes, a multimedia message will always be retrieved by the recipient MMS User Agent 1018 from the recipient MMS Relay/Server 1014. Involved abstract messages are outlined in Table 7 from type and direction points of view.

TABLE 7
Abstract messages for retrieval of multimedia message in MMS

| Abstract messages | Type | Direction |
|---|---|---|
| MM1_retrieve.REQ 1114 | Request | MMS UA 1018 −> MMS Relay/Server 1014 |
| MM1_retrieve.RES 1116 | Response | MMS Relay/Server 1014 −> MMS UA 1018 |
| MM1_acknowledgement.REQ 1118 | Request | MMS UA 1018 −> MMS Relay/Server 1014 |

During normal operation, the recipient MMS User Agent 1018 will issue an MM1_retrieve.REQ 1114 to the recipient MMS Relay/Server 1014 to initiate the retrieval process. The recipient MMS Relay/Server 1014 will respond with an MM1_retrieve.RES 1116, which contains multimedia messages control information and the multimedia message content. After receiving the MM1_retrieve.RES 1116, the recipient MMS User Agent 1018 will send an MM1_acknowledgement.REQ 1118 to the corresponding MMS Relay/Server 1014, if requested by the MMS Relay/Server 1014. The MM1_acknowledgement.REQ 1118 will unambiguously refer to the corresponding MM1_retrieve.RES 1116.

During abnormal operation, if the recipient MMS Relay/Server 1014 can not process the MM1_retrieve.REQ 1114, for example due to invalid content location or expiration of the message, the recipient MMS Relay/Server 1014 will respond with either an MM1_retrieve.RES 1116 or a lower protocol layer error message encapsulating a status which indicates the reason to the recipient MMS User Agent 1018 the multimedia message was not delivered. If the recipient MMS Relay/Server 1014 does not provide the MM1_retrieve.RES 1116 or the lower protocol layer error message the recipient MMS User Agent 1018 should be able to recover.

The recipient MMS User Agent 1018 will always provide a reference, e.g., URI, for the multimedia message in the MM1_retrieve.REQ 1114. The multimedia message originator address may be provided to the recipient MMS User Agent 1018 in the addressing-relevant information field of MM1_retrieve.RES 1116. The multimedia message originator address will not be provided to the recipient MMS User Agent 1018 if the multimedia message originator has requested his or her address to be hidden from the multimedia message recipient. One or several address(es) of the multimedia message recipient(s) may be provided to the recipient MMS User Agent 1018 in the addressing-relevant information field(s) of the MM1_retrieve.RES 1116. The MM1_retrieve.RES 1116 will carry the time and date of submission of the multimedia message or the time and date of the forwarding of the multimedia message. In the case of reply-charging, the deadline for the latest time of submission of a multimedia message reply will be conveyed within the MM1_retrieve.RES 1116. Information about class, priority, subject of the multimedia message will be included in the MM1_retrieve.RES 1116 according to their presence and value received at the recipient MMS Relay/Server 1014. Information about additional end-to-end qualifiers of the multimedia message should be included in the MM1_retrieve.RES 1116 according to their presence and value received at the recipient MMS Relay/Server 1014. If the originator MMS User Agent 1008 requested a read-reply report, the recipient MMS Relay/Server 1014 will convey this information in the MM1_retrieve.RES 1116. If the originator MMS User Agent 1008 requested a delivery report, the recipient MMS Relay/Server 1014 may convey this information to the recipient MMS User Agent 1018 in the MM1_retrieve.RES 1116. If a request for a delivery report is included in the MM1_retrieve.RES 1116, the recipient MMS User Agent 1018 will convey the information whether it accepts or denies the sending of a delivery report to the multimedia message originator in MM1_acknowledgement.REQ 1118. If a delivery report is not requested, it is up to the recipient MMS User Agent 1018 to include this information in MM1_acknowledgement.REQ 1118 or not. In the case of reply-charging, the recipient MMS Relay/Server 1014 should indicate in the MM1_retrieve.RES 1116 that a reply to this particular original multimedia message is free of charge. The recipient MMS Relay/Server 1014 will provide a message identification for a message, which it has accepted for delivery in the MM1_retrieve.RES 1116. In the case of reply-charging, the recipient MMS Relay/Server 1014 will provide the message-ID of the original multimedia message which is replied to in the MM1_retrieve.RES 1116. The type of the multimedia message content will always be identified in the MM1_retrieve.RES 1116. The content of the multimedia message, if added by the originator MMS User Agent 1008 may be conveyed in the MM1_retrieve.RES 1116. In case of normal operation, the recipient MMS Relay/Server 1014 may indicate in the MM1_retrieve.RES 1116 that the retrieval of the multimedia message was processed correctly. In case of abnormal operation, the recipient MMS Relay/Server 1014 will indicate in the MM1_retrieve.RES 1116 the reason why the multimedia message could not be retrieved. The corresponding reason codes should cover application level errors (e.g. ‘the media format could not be converted’, ‘insufficient credit for retrieval’). Lower layer errors may be handled by corresponding protocols. A Counter indicating the number of times the particular multimedia message was forwarded may also be included. The address of the forwarding MMS User Agent and multiple addresses are possible. In the multiple address case, this is a sequential list of the address(es) of the forwarding MMS User Agents who forwarded the same multimedia message.

TABLE 8
Information elements in the MM1_retrieve.REQ 1114.

| Information element | Presence | Description |
|---|---|---|
| Message Reference | Mandatory | Location of the content of the |
| | | multimedia message to be retrieved. |

TABLE 9
Information elements in the MM1_retrieve.RES 1116,
as defined in WAP-209 and 3GPP 23.140.

| Information element | Presence | Description |
|---|---|---|
| Message ID | Mandatory | The message ID of the multimedia message. |
| Sender address | Conditional | The address of the originator of multimedia |
| | | message unless the originator MMS User Agent |
| | | 1008 has requested her address to be hidden from |
| | | the multimedia message recipient. |
| Content type | Mandatory | The content type of the multimedia message's |
| | | content. |
| Recipient address | Optional | The address of the multimedia message recipient. |
| | | Multiple addresses are possible. |
| Message class | Optional | The class of the message (e.g., personal, |
| | | advertisement, information service). |
| Date and time | Mandatory | The time and date of the submission of the |
| | | multimedia message or the time and date of the |
| | | forwarding of the multimedia mess age (time |
| | | stamp). |
| Delivery report | Optional | A request for delivery report. |
| Priority | Conditional | The priority (importance) of the message if |
| | | specified by the originator MMS User Agent 1008. |
| Read reply | Conditional | A request for read-reply report if the originator |
| | | MMS User Agent 1008 of the multimedia message |
| | | has requested a read-reply report. |
| Subject | Conditional | The title of the whole multimedia message if |
| | | specified by the originator MMS User Agent 1008 |
| | | of the multimedia message. |
| Status | Optional | The status of the multimedia message retrieve |
| | | request. |
| Status Text | Optional | Description which qualifies the status of the |
| | | multimedia message retrieve request. |
| Reply-Charging | Optional | Information that a reply to this particular original |
| | | multimedia message is free of charge. |
| Reply-Charging-ID | Optional | In case of reply-charging this is the identification |
| | | of the original multimedia message replied to. |
| Reply-Deadline | Optional | In case of reply-charging the latest time of |
| | | submission of a reply granted to the recipient. |
| Forward_counter | Conditional | A Counter indicating the number of times the |
| | | particular multimedia message was forwarded. |
| Forwarded_by | Conditional | The address of the forwarding MMS User Agent. |
| | | Multiple addresses are possible. In the multiple |
| | | address case this is a Sequential list of the |
| | | address(es) of the forwarding MMS User Agents |
| | | who forwarded the same multimedia message. |
| Content | Conditional | The content of the multimedia message if specified |
| | | by the originator MMS User Agent 1008 of the |
| | | multimedia message. |

TABLE 10
Information elements in the MM1_acknowledgement.REQ 1118.

| Information element | Presence | Description |
|---|---|---|
| Report allowed | Optional | Request to allow or disallow the |
| | | sending of a delivery report to the |
| | | multimedia message originator. |

Forwarding of Multimedia Messages—This part of the MMS service describes the mechanism by which a forwarding MMS User Agent can request from the corresponding MMS Relay/Server, that a multimedia message for which the MMS User Agent is the intended recipient (and is notified of the multimedia message) be forwarded to other specified recipient(s) MMS User Agent(s) whose address(es) will be specified by the forwarding MMS User Agent, without having to first retrieve the multimedia message. For forwarding purposes a multimedia message forward request will always be requested by the forwarding MMS User Agent from the forwarding MMS Relay/Server. Involved abstract messages are outlined in Table 11 from type and direction points of view.

TABLE 11
Abstract messages for forwarding of multimedia
message without prior retrieval

| Abstract messages | Type | Direction |
|---|---|---|
| MM1_forward.REQ | Request | MMS UA −> MMS Relay/Server |
| MM1_forward.RES | Response | MMS Relay/Server −> MMS UA |

During normal operation, the forwarding MMS User Agent will issue an MM1_forward.REQ to the forwarding MMS Relay/Server, which contains MMS control information. The MMS Relay/Server will respond with an MM1_forward.RES, which provides the status of the request. The MM1_forward.RES will unambiguously refer to the corresponding MM1_forward.REQ. Support for MM1_forward.REQ is optional for the MMS User Agent. Support for MM1_forward.RES is optional for the MMS Relay/Server.

During abnormal operation, the MMS Relay/Server will respond with an MM1_forward.RES encapsulating a status which indicates the reason the request for forwarding was not accepted, e.g. no subscription, service not available, invalid content location, message expired. If the MMS Relay/Server does not provide the MM1_forward.RES the MMS User Agent should be able to recover.

One or several recipients of a multimedia message forward request will be indicated in the addressing-relevant information field(s) of the MM1_forward.REQ. The forwarding MMS User Agent may be indicated in addressing-relevant information field(s) of the MM1_forward.REQ. The forwarding MMS User Agent may time stamp the multimedia message. The forwarding MMS User Agent may request an earliest desired time of delivery of the multimedia message. The forwarding MMS User Agent may request an expiration period or time for the multimedia message. The forwarding MMS User Agent may request a delivery report for the multimedia message. In addition, the forwarding MMS User Agent may request a read-reply report when the user has viewed the multimedia message. The MMS Relay/Server of the forwarding MMS User Agent will always provide a message identification for a multimedia message forward request, which it has accepted for being forwarded in the MM1_forward.RES. The forwarding MMS User Agent will always provide the reference, e.g., URI, for the multimedia message in the MM1₁₃forward.REQ which was provided in MM1_notification.REQ. The MMS Relay/Server of the forwarding MMS User Agent will indicate the status of the MM1_forward.REQ in the MM1_forward.RES. The reason code given in the status information element of the MM1forward.RES may be supported with an explanatory text further qualifying the status. If this text is available in the status text information element the MMS User Agent should bring it to the user's attention. The choice of the language used in the status text information element is at the discretion of the MMS service provider.

TABLE 12
Information elements in the MM1_forward.REQ.

| Information element | Presence | Description |
|---|---|---|
| Recipient address | Mandatory | The address of the recipient of the |
| | | forwarded multimedia message. |
| | | Multiple addresses are possible. |
| Forwarding address | Optional | The address of the forwarding MMS |
| | | User Agent. |
| Date and time | Optional | The time and date of the forwarding |
| | | of the multimedia message. |
| Time of Expiry | Optional | The desired time of expiry for the |
| | | forwarded multimedia message. |
| Earliest delivery time | Optional | The earliest desired time of delivery |
| | | of the multimedia message to the |
| | | recipient. |
| Delivery report | Optional | A request for delivery report for |
| | | the forwarded multimedia message. |
| Read reply | Optional | A request for read reply report. |
| Message Reference | Mandatory | A reference, e.g., URI, for the |
| | | multimedia message, |

TABLE 13
Information elements in the MM1_forward.RES.

| Information element | Presence | Description |
|---|---|---|
| Status | Mandatory | The status of the multimedia message |
| | | Forward request. |
| Status Text | Optional | Description which qualifies the status of |
| | | the multimedia message Forward |
| | | request. |
| Message ID | Mandatory | The identification of the multimedia |
| | | message given to an accepted |
| | | multimedia message. |

Delivery Report—This part of MMS service covers the sending of delivery report from originator MMS Relay/Server 1004 to the originator MMS User Agent 1008. The involved abstract message is outlined in Table 14 from type and direction points of view.

TABLE 14
Abstract message for sending delivery reports in MMS.

| Abstract Message | Type | Direction |
|---|---|---|
| MM1_delivery_report.REQ 1124 | Request | MMS Relay/Server 1004 −> MMS UA 1008. |

During normal operation, the originator MMS Relay/Server 1004 will (subject to user, MMS service provider and/or operator preferences) create the MM1_delivery_report.REQ 1124 and send it to the originator MMS User Agent 1008 when the appropriate information for the creation of a delivery report is available. Support for MM1_delivery_report.REQ 112K is optional for the origination 1008 MMS User Agent but mandatory for the origination MMS Relay/Server 1004.

During abnormal operation, the MMS protocol framework does not provide mechanisms to cover and handle the unsuccessful delivery of MM1_delivery report.REQ 1124. The underlying protocols will provide reliable transport of MM1_delivery_report.REQ 1124.

In the MM1_delivery_report.REQ 1124, the originator MMS Relay/Server 1004 will always provide the original message identification of the multimedia message that the delivery report corresponds to. The multimedia message recipient address will be provided to the originator MMS User Agent 1008 in the addressing-relevant information field of MM1_delivery_report.REQ 1124. The MM1_delivery report.REQ 1124 will carry the time and date of handling of the multimedia message (e.g. retrieval, expiration, rejection). The MM1_delivery_report.REQ 1124 will carry the status of the multimedia message delivery, e.g. retrieved, forwarded, rejected, expired or indeterminate.

TABLE 15
Information elements in the MM1_delivery_report.REQ 1124.

| Information element | Presence | Description |
|---|---|---|
| Message ID | Mandatory | The identification of the original multimedia |
| | | message. |
| Recipient address | Mandatory | The address of the multimedia message recipient |
| | | of the original multimedia message. |
| Event Date | Mandatory | Date and time the multimedia message was |
| | | handled (retrieved, expired, rejected, etc.) (time stamp) |
| Multimedia | Mandatory | Status of the multimedia message, e.g. retrieved, |
| Message Status | | forwarded, expired, rejected |

Read-Reply Report—This part of MMS service covers the sending of read-reply report from the recipient MMS User Agent 1018 to the recipient MMS Relay/Server 1014 and the sending of read-reply report from the originator MMS Relay/Server 1004 to the originator MMS User Agent 1008. The involved abstract messages are outlined in Table 16 from type and direction points of view.

TABLE 16
Abstract messages for sending and receiving read-reply report in MMS.

| Abstract messages | Type | Direction |
|---|---|---|
| MM1_read reply recipient.REQ 1126 | Request | MMS UA 1018 −> MMS Relay/Server 1014 |
| MM1_read reply originator.REQ 1132 | Request | MMS Relay/Server 1004 −> MMS UA 1008 |

During normal operation, if a read-reply report is requested for an multimedia message, the recipient MMS User Agent 1018 may create the MM1_read_reply_recipient.REQ 1126 and send it to the recipient MMS Relay/Server 1014. The originator MMS Relay/Server 1004 will (subject to user, MMS service provider and/or operator preferences) create the MM1_read_reply_originator.REQ 1132 and send it to the originator MMS User Agent 1008 when the appropriate information for the creation of a read-reply report is available. Support for MM1_read_reply_recipient.REQ 1126 and MM1_read_reply_originator.REQ 1132 is optional for the MMS User Agent 1008 and 1018 but mandatory for the MMS Relay/Server 1004 and 1014.

During abnormal operation, the MMS protocol framework does not provide mechanisms to cover and handle the unsuccessful delivery of MM1_read_reply_recipient.REQ 1126 and MM1_read_reply_originator.REQ 1132.

In the MM1_read_reply_recipient.REQ 1126, the recipient MMS User Agent 1018 will provide the original message identification of the multimedia message that the read-reply report corresponds to. In the MM1_read_reply_originator.REQ 1132, the originator MMS Relay/Server 1004 will provide the original message identification of the multimedia message that the read-reply report corresponds to. The multimedia message originator address will be provided in the addressing-relevant information field(s) of MM1_read_reply_recipient.REQ 1126. The multimedia message recipient address will be provided in the addressing-relevant information field(s) of MM1_read_reply recipient.REQ 1126. Both, the multimedia message recipient and multimedia message originator addresses will be provided in the addressing-relevant information field(s) of the MM1_read_reply_originator.REQ 1132. If the multimedia message recipient address is not yet provided in the MM1_read_reply recipient.REQ 1126, the MM1_read_reply_originator.REQ 1132 will carry the multimedia message recipient address set by the recipient MMS Relay/Server 1014. The MM1_read_reply_recipient.REQ 1126 may carry the time and date of user handling the multimedia message depending on the status of the multimedia message. The MM1_read_reply_originator.REQ 1132 will carry the time-stamp from the corresponding MM1_read_reply_recipient.REQ 1126 if provided. If this time-stamp is not yet provided, the MM1_read_reply_originator.REQ 1132 will carry the time-stamp set by the recipient MMS Relay/Server 1014 multimedia message. Both the MM1_read_reply_recipient.REQ 1126 and MM1_read_reply_originator.REQ 1132 will carry the status of the multimedia message retrieval, e.g. read or without being read.

TABLE 17
Information elements in the MM1_read_reply recipient.REQ 1126.

| Information element | Presence | Description |
|---|---|---|
| Recipient address | Mandatory | The address of the multimedia message recipient of |
| | | the original multimedia message, i,e, the originator |
| | | of the read-reply report. |
| Originator address | Mandatory | The address of the multimedia message originator |
| | | of the original multimedia message, i,e, the |
| | | recipient of the read-reply report. |
| Message-ID | Mandatory | The message ID of the original multimedia |
| | | message. |
| Date and Time | Optional | Date and time the multimedia message was handled |
| | | (read, deleted without being read, etc.) (time stamp) |
| Status | Mandatory | Status of the multimedia message, e.g. Read, |
| | | Deleted without being read |

TABLE 18
Information elements in the MM1_read_reply originator.REQ 1132.

| Information element | Presence | Description |
|---|---|---|
| Recipient address | Mandatory | The address of the multimedia message recipient of |
| | | the original multimedia message, i,e, the originator |
| | | of the read-reply report. |
| Originator address | Mandatory | The address of the multimedia message originator |
| | | of the original multimedia message, i,e, the |
| | | recipient of the read-reply report. |
| Message-ID | Mandatory | The message ID of the original multimedia |
| | | message. |
| Date and Time | Mandatory | Date and time the multimedia message was handled |
| | | (read, deleted without being read, etc.) (time stamp) |
| Multimedia Message | Mandatory | Status of the multimedia message, e.g. Read, |
| Status | | Deleted without being read |

The interworking between MMS Relay/Servers and External Servers may be based on the Internet Protocol, IP. Messages between MMS Relay/Servers and External Servers, also referred to as MM3 messages, should be based upon existing standards e.g. HTTP, SMTP. In addition, MMS service providers or network operators may develop solutions for their particular needs.

Sending of multimedia messages—For the purpose of sending a multimedia message to an external messaging system, the originator MMS Relay/Server should convert the multimedia message into a format appropriate for the external messaging system. The originator MMS Relay/Server should use the information elements associated with the multimedia message to define the control information needed for the transfer protocol in use. The originator MMS Relay/Server may use the information elements associated with the multimedia message to convey these as part of the converted message. For example, the originator MMS Relay/Server should use the recipient's address(es) as indicated in the corresponding multimedia message to route the converted message towards its recipient(s). In addition, the originator MMS Relay/Server may convey message class, priority and subject of the associated multimedia message as part of the converted message.

Receiving of messages—For the purpose of receiving a message from an external messaging system, the recipient MMS Relay/Server should convert incoming messages to the multimedia message format in use by the recipient(s) that form part of the recipient MMS Service Provider's domain. The recipient MMS Relay/Server may convert control information received from the External Server into appropriate information elements of an multimedia message. For example, the recipient MMS Relay/Server should use the MSISDNs associated with an SMS-Short Message to define the sender's and recipient's addresses of the multimedia message. In addition the MMS Relay/Server may map a priority assigned to an incoming SMS-Short Message to the multimedia message's priority.

Discovery of new messages on External Servers—Different mechanisms may be used for the discovery of incoming messages from external messaging systems. For example, forwarding of messages from the External Server to the MMS Relay/Server, based on criteria defined by the user or application; notification of messages from an External Server, followed by retrieval by the MMS User Agent via the MMS Relay/Server; periodic polling for messages on External Server, followed by retrieval by the MMS User Agent via the MMS Relay/Server.

Routing Forward of a Multimedia Message—This part of MMS service covers the routing forward of an multimedia message from an originator MMS Relay/Server 1004 to a recipient MMS Relay/Server 1014 of different MMSEs. Involved abstract messages are outlined in Table 19 from type and direction points of view.

TABLE 19
Abstract messages for forwarding of multimedia message in MMS.

| Abstract messages | Type | Direction |
|---|---|---|
| MM4_forward.REQ 1106 | Request | Originator MMS Relay/Server 1004 −> recipient |
| | | MMS Relay/Server 1014. |
| MM4_forward.RES 1108 | Response | Recipient MMS Relay/Server 1014 −> originator |
| | | MMS Relay/Server 1004. |

During normal operation and after successfull discovery of its peer entity, the originator MMS Relay/Server 1104 will route a multimedia message forward to the recipient MMS Relay/Server 1014 using the MM4_forward.REQ 1106, which contains MMS control information and the multimedia message content. The recipient MMS Relay/Server 1014 will respond with a MM4_forward.RES 1108, which provides the status of the request if an MM4_forward.RES 1108 was requested. Support for MM4_forward.REQ 1106 and MM4_forward.RES 1108 is mandatory for the MMS Relay/Servers 1004 and 1014.

During abnormal operation, the recipient MMS Relay/Server 1014 will respond with a MM4_forward.RES 1108, which includes a status that indicates the reason the multimedia message was not accepted, e.g. no subscription, bad address, network not reachable, etc., if an MM4_forward.RES 1108 was requested.

The recipient(s) of a routed forward multimedia message will be indicated in the addressing-relevant information field(s) of the MM4_forward.REQ 1106. If the addresses of several multimedia message recipients of the multimedia message are associated with a single MMSE then more than one multimedia message recipient may be indicated in the addressing-relevant information field(s) of the MM4_forward.REQ 1106. Addresses of all multimedia message recipients of the multimedia message (including those that are not associated with the MMSE the multimedia message is forwarded to) will be conveyed in the MM4_forward.REQ 1106 for the multimedia message recipient's informational purposes. The multimedia message originator of a routed forward multimedia message shall be indicated in addressing-relevant information field(s) of the MM4_forward.REQ 1106. If the originator MMS User Agent 1008 requested to hide its identity from the multimedia message recipient then the information about this request will also be conveyed in the MM4_forward.REQ 1106. The MM4_forward.REQ 1106 will carry the time-stamp associated with the multimedia message. If the originator MMS User Agent 1008 requested an expiration period or time for the multimedia message, then this information will be conveyed in the MM4_forward.REQ 1106. If the multimedia message is qualified further by message class, priority, subject and/or additional qualifiers then this information will be conveyed in the MM4_forward.REQ 1106. If the originator MMS User Agent 1008 requested a delivery report for the multimedia message, then the information about this request will be conveyed in the MM4_forward.REQ 1106. If, in addition, the originator MMS User Agent 1008 requested a read-reply report then the information about this request will be conveyed in the MM4_forward.REQ 1106. The originator MMS Relay/Server 1008 will always provide a unique message identification for a multimedia message, which it routed forward to a peer MMS Relay/Server in the MM4_forward.REQ 1106. The type of the multimedia content will always be identified in the MM4_forward.REQ 1106. The originator MMS Relay/Server 1004 may request a MM4_forward.RES 1108 from the recipient MMS Relay/Server 1014 acknowledging the successful reception of the multimedia message. The recipient MMS Relay/Server 1014 will indicate the status of the MM4_forward.REQ 1106 in the associated MM4_forward.RES 1108 if requested. The type of message used on reference point MM4 will also be indicated in the MM4_forward.REQ 1106 and MM4_forward.RES 1108. If the originator MMS Relay/Server 1004 requests an MM4_forward.RES 1108 from the recipient MMS Relay/Server 1014, it will provide a transaction identification within an MM4_forward.REQ 1106. The MM4_forward.RES 1108 will unambiguously refer to the corresponding MM4_forward.REQ 1106 using the same transaction identification. A Counter indicating the number of times the particular multimedia message was forwarded may also be involved. The address of the forwarding MMS User Agent and multiple addresses are possible. In the multiple address case, this is a Sequential list of the address(es) of the forwarding MMS User Agents who forwarded the same multimedia message. The MMS protocol will provide unique means to identify the current version in the particular protocol environment.

TABLE 20
Information elements in the MM4_forward.REQ 1106,
as defined in WAP-209 and 3GPP 23.149.

| Information element | Presence | Description |
|---|---|---|
| 3GPP MMS Version | Mandatory | The MMS version of the originator MMS |
| | | Relay/Server 1004 as defined by this |
| | | specification. |
| Message Type | Mandatory | The type of message used on reference point |
| | | MM4: “MM4_forward.REQ”. |
| Transaction ID | Mandatory | The identification of the MM4_forward.REQ/ |
| | | MM4_forward.RES pair. |
| Message ID | Mandatory | The identification of the multimedia message. |
| Recipient(s) address | Mandatory | The address(es) of the multimedia message |
| | | recipient(s). Multiple addresses are possible. |
| Sender address | Mandatory | The address of the multimedia message |
| | | originator. |
| Content type | Mandatory | The content type of the multimedia message's |
| | | content. |
| Message class | Conditional | The class of the multimedia message (e.g., |
| | | personal, advertisement, information service) if |
| | | specified by the originator MMS User Agent 1008. |
| Date and time | Mandatory | The time and date of the submission of the |
| | | multimedia message(time stamp) or the time and |
| | | date of the forwarding of the multimedia |
| | | message. |
| Time of Expiry | Conditional | The desired time of expiry for the multimedia |
| | | message if specified by the originator MMS User |
| | | Agent 1008. |
| Delivery report | Conditional | A request for delivery report if the originator |
| | | MMS User Agent 1008 has requested a delivery |
| | | report for the multimedia message. |
| Priority | Conditional | The priority (importance) of the message if |
| | | specified by the originator MMS User Agent |
| | | 1008. |
| Sender visibility | Conditional | A request to show or hide the sender's identity |
| | | when the message is delivered to the multimedia |
| | | message recipient if the originator MMS User |
| | | Agent 1008 has requested her address to be |
| | | hidden from the recipient. |
| Read reply | Conditional | A request for read reply report if the originator |
| | | MMS User Agent 1008 has requested a read- |
| | | reply report for the multimedia message. |
| Subject | Conditional | The title of the whole multimedia message if |
| | | specified by the originator MMS User Agent 1008. |
| Acknowledgement | Optional | Request for MM4_forward.RES |
| Request | | |
| Forward_counter | Conditional | A counter indicating the number of times the |
| | | particular multimedia message was forwarded. |
| Forwarded_by | Conditional | The address of the forwarding MMS User Agent. |
| | | Multiple addresses are possible. In the multiple |
| | | address case this is a Sequential list of the |
| | | address(es) of the forwarding MMS User Agents |
| | | who forwarded the same multimedia message. |
| Content | Conditional | The unaltered content of the multimedia message |
| | | if specified by the originator MMS User Agent |
| | | 1008. |

TABLE 21
Information elements in the MM4_forward.RES 1108.

| Information element | Presence | Description |
|---|---|---|
| 3GPP MMS Version | Mandatory | The MMS version of the recipient MMS |
| | | Relay/Server 1014 as defined by this |
| | | specification. |
| Message Type | Mandatory | The type of message used on reference |
| | | point MM4: “MM4_forward.RES”. |
| Transaction ID | Mandatory | The identification of the |
| | | MM4_forward.REQ/ |
| | | MM4_forward.RES pair. |
| Message ID | Mandatory | The Message ID of the multimedia |
| | | message which has been forwarded |
| | | within the corresponding |
| | | MM4_forward.REQ |
| Request Status Code | Mandatory | The status of the request to route |
| | | forward the multimedia message. |
| Status text | Optional | Status text corresponding to the code |

Routing Forward of a Delivery Report—This part of MMS service covers the routing forward of a delivery report from recipient MMS Relay/Server 1014 to originator MMS Relay/Server 1004. The involved abstract messages are outlined in Table 22 from type and direction points of view.

TABLE 22
Abstract messages for routing delivery reports forward in MMS.

| Abstract Message | Type | Direction |
|---|---|---|
| MM4_delivery report.REQ 1120 | Request | Recipient MMS Relay/Server 1014 −> originator |
| | | MMS Relay/Server 1004 |
| MM4_delivery report.RES 1122 | Response | Originator MMS Relay/Server 1004 −> recipient |
| | | MMS Relay/Server 1014 |

During normal operation and after successful discovery of its peer entity, the recipient MMS Relay/Server 1014 will route a previously created delivery report forward to the originator MMS Relay/Server 1004 using the MM4_delivery_report.REQ 1120, which contains MMS control information only. The originator MMS Relay/Server 1004 will respond with a MM4_delivery report.RES 1122, which provides the status of the MM4_delivery_report.REQ 1120 if an MM4_delivery_report.RES 1122 was requested. Support for MM4_delivery_report.REQ 1120 and MM4_delivery_report.RES 1122 is mandatory for the MMS Relay/Servers 1004 and 1014.

During abnormal operation, the originator MMS Relay/Server 1004 will respond with a MM4_delivery_report.RES 1122 encapsulating a status which indicates the reason the delivery report was not accepted, if an MM4_delivery_report.RES 1122 was requested.

Both the address of the recipient (which is the multimedia message originator) and the address of the originator (which is the multimedia message recipient) of a routed forward delivery report will be provided to the originator MMS Relay/Server 1004 in the addressing-relevant information field of MM4_delivery_report.REQ 1120. In the MM4_delivery_report.REQ 1120 the recipient MMS Relay/Server 1014 will always provide the original message identification of the multimedia message that the delivery report corresponds to as obtained from the associated MM4_forward.REQ 1106 multimedia message. The MM4_delivery_report.REQ 1120 will carry the time and date of handling of the multimedia message (e.g. retrieval, expiry, rejection). The MM4_delivery_report.REQ 1120 will carry the status of the multimedia message delivery, e.g. retrieved, rejected, expired or indeterminate. The recipient MMS Relay/Server 1014 may request a MM4_delivery_report.RES 1122 from the originator MMS Relay/Server 1004 acknowledging the successful reception of the delivery report. The originator MMS Relay/Server 1004 will indicate the status of the MM4_delivery_report.REQ 1120 in the associated MM4_delivery report.RES 1122 if requested. The MMS protocol will provide unique means to identify the current version in the particular protocol environment. The type of message used will be indicated in MM4_delivery_report.REQ 1120 and MM4_delivery report.RES 1122. If the originator MMS Relay/Server 1004 requests an MM4_delivery_report.RES 1122 from the recipient MMS Relay/Server 1014, it will provide a transaction identification within a MM4_delivery_report.REQ 1120. The MM4_delivery_report.RES 1122 will unambiguously refer to the corresponding MM4_delivery_report.REQ 1120 using the same transaction identification.

TABLE 23
Information elements in the MM4_delivery_report.REQ 1120,
as defined in 3GPP 23.140.

| Information element | Presence | Description |
|---|---|---|
| 3GPP MMS Version | Mandatory | The MMS version of the recipient MMS |
| | | Relay/Server 1014 as defined by this |
| | | specification. |
| Message Type | Mandatory | The type of message used on reference point MM4: |
| | | “MM4_delivery_report.REQ”. |
| Transaction ID | Mandatory | The identification of the |
| | | MM4_delivery_report.REQ/ |
| | | MM4_delivery_report.RES pair. |
| MM Message ID | Mandatory | The identification of the original multimedia |
| | | message. |
| Recipient address | Mandatory | The address of the multimedia message |
| | | recipient of the original multimedia message. |
| Sender address | Mandatory | The address of the multimedia message |
| | | originator of the original multimedia message. |
| MM Date and time | Mandatory | Date and time the multimedia message was |
| | | handled (retrieved, expired, rejected, etc.) |
| Acknowledgement | Optional | Request for MM4_delivery_report.RES. |
| Request | | |
| MM Status Code | Mandatory | Status of the multimedia message, e.g. |
| | | retrieved, expired, rejected. |
| Status text | Optional | Status text corresponding to the Status code. |

TABLE 24
Information elements in the
MM4_delivery_report.RES 1122.

| Information | | |
|---|---|---|
| element | Presence | Description |
| 3GPP MMS | Mandatory | The MMS version of the recipient MMS |
| Version | | Relay/Server as defined by this specification. |
| Message Type | Mandatory | The type of message used on reference point |
| | | MM4: “MM4_delivery_reportRES”. |
| Transaction ID | Mandatory | The identification of the |
| | | MM4_delivery_report.REQ/ |
| | | MM4_delivery_report.RES pair. |
| Message ID | Mandatory | The Message ID of the multimedia message |
| | | which caused the delivery report. |
| Request Status | Mandatory | The status of the associated |
| Code | | MM4_delivery_report.REQ. |
| Status text | Optional | The text explanation corresponding to the |
| | | Status code. |

Routing Forward of a Read-Reply Report—This part of MMS service covers the routing forward of a read-reply report from the recipient MMS Relay/Server 1014 to the originator MMS Relay/Server 1004. The involved abstract messages are outlined in Table 25 from type and direction points of view.

TABLE 25
Abstract messages for sending and receiving read-reply reports in MMS.

| Abstract messages | Type | Direction |
|---|---|---|
| MM4_read_reply.REQ 1128 | Request | Recipient MMS Relay/Server 1014 −> originator |
| | | MMS Relay/Server 1004. |
| MM4_read_reply.RES 1130 | Response | Originator MMS Relay/Server 1004 −> recipient |
| | | MMS Relay/Server 1014. |

During normal operation and after successful discovery of its peer entity, the recipient MMS Relay/Server 1014 will route a read-reply report forward that has been previously submitted by the recipient MMS User Agent 1018, to the originator MMS Relay/Server 1004 using the MM4_read_reply_report.REQ 1128, which contains MMS control information only. The recipient MMS Relay/Server 1014 will respond with a MM4_read_reply_report.RES 1130, which provides the status of the MM4_read_reply_report.REQ 1128 if an MM4_read_reply_report.RES 1130 was requested. Support for MM4_read_reply_report.REQ 1128 and MM4_read_reply_report.RES 1130 is mandatory for the MMS Relay/Server 1004 and 1014.

During abnormal operation, the originator MMS Relay/Server 1004 will respond with a MM4_read_reply_report.RES 1128 encapsulating a status which indicates the reason the read-reply report was not accepted, if an MM4_read_reply_report.RES 1128 was requested.

Both the address of the recipient (which is the multimedia message originator) and the address of the originator (which is the multimedia message recipient) of a routed forward read-reply report will be provided to the originator MMS Relay/Server 1004 in the addressing-relevant information field of MM4_read_reply_report.REQ 1128. In the MM4_read_reply_report.REQ 1128, the recipient MMS Relay/Server 1014 will always provide the original message identification of the multimedia message that the read-reply report corresponds to as obtained from the associated MM4_forward.REQ 1128 multimedia message. The MM4_read_reply_report.REQ 1128 will carry the time-stamp associated with the read-reply report. The MM4_read_reply_report.REQ 1128 will carry the status of the multimedia message retrieval, e.g. read or without being read. The recipient MMS Relay/Server 1014 may request a MM4_read_reply_report.RES 1130 from the originator MMS Relay/Server 1004 acknowledging the successful reception of the read-reply report. The originator MMS Relay/Server 1004 will indicate the status of the MM4_read_reply.REQ 1128 in the associated MM4_read_reply.RES 1130 if requested. The MMS protocol will provide unique means to identify the current version in the particular protocol environment. The type of message used will be indicated in MM4_read_reply.REQ 1128 and MM4_read_reply.RES 1130. If the recipient MMS Relay/Server 1014 requests an MM4_read_reply_report.RES 1130 from the originator MMS Relay/Server 1004, it will provide a transaction identification within an MM4_read_reply_report.REQ 1128. The MM4_read_reply_report._RES 1130 will unambiguously refer to the corresponding MM4_read_reply_report.REQ 1128 using the same transaction identification.

TABLE 26
Information elements in the MM4_read_reply_report.REQ, as defined in 3GPP 23.140.

| Information element | Presence | Description |
|---|---|---|
| 3GPP MMS Version | Mandatory | The MMS version of the recipient MMS |
| | | Relay/Server as defined by this specification. |
| Message Type | Mandatory | The type of message used on reference point |
| | | MM4: “MM4_read_reply_report.REQ”. |
| Transaction ID | Mandatory | The identification of the |
| | | MM4_read_reply_report.REQ/ |
| | | MM4_read_reply_report.RES pair. |
| Recipient address | Mandatory | The address of the multimedia message |
| | | recipient of the original MM, i.e. the originator |
| | | of the read-reply report. |
| Sender address | Mandatory | The address of the multimedia message |
| | | originator of the original MM, i.e. the recipient |
| | | of the read-reply report. |
| Message-ID | Mandatory | The message ID of the original multimedia |
| | | message. |
| Date and time | Mandatory | Date and time the multimedia message was |
| | | handled (read, deleted without being read, etc.) |
| | | (time stamp) |
| Acknowledgement | Optional | Request for MM4_delivery_report.RES |
| Request | | |
| MM Status Code | Mandatory | Status of the MM, e.g. Read, Deleted without being read |
| Status text | Optional | The text explanation corresponding to the |
| | | Status code |

TABLE 27
Information elements in the MM4_read_reply_report.RES.

| Information | | |
|---|---|---|
| element | Presence | Description |
| 3GPP MMS | Mandatory | The MMS version of the recipient MMS |
| Version | | Relay/Server as defined by this specification. |
| MM Message | Mandatory | The type of message used on reference point |
| Type | | MM4: “MM4_read_reply_report.RES”. |
| Transaction ID | Mandatory | The identification of the |
| | | MM4_read_reply_report.REQ/ |
| | | MM4_read_reply_report.RES pair. |
| Request Status | Mandatory | The status of the associated |
| Code | | MM4_read_reply_report.REQ. |
| Status text | Optional | The textual explanation for the Status code |

Message format on MM4—All elements of a multimedia message will be included within a single SMTP “mail” message which will be organized as MIME type application/multipart. All multimedia message elements will be of standard MIME content types. In addition to the multimedia message elements this SMTP “mail” message should reflect all relevant MMS information elements. All other MMS-related messages, such as delivery reports, read-reply reports, transfer acknowledgements will each be transferred as a single SMTP “mail” message which will be organised as MIME type text/plain. This SMTP “mail” message should reflect all MMS information elements as defined above.

Message header fields—MMS information elements should be reflected as “header fields” according to STD 11 in the SMTP “mail” message. Some of the mappings are context dependent. For those information elements that cannot be mapped to standard STD 11 “header fields” the “X-” extensions mechanism will be used with an “X-MMS-” prefix. The mapping of information elements to commonly used (RFC 1327) or standard STD 11 “header fields” is shown in following tables.

MM4_forward.REQ Header Mappings—The MM4 Forward request header mappings are detailed below.

TABLE 28
MM4_forward.REQ 1106 Information Elements to STD 11 Header
Mappings, as defined in 3GPP 23.140

| Information element | STD 11 Headers |
|---|---|
| 3GPP MMS Version | X-Mms-3GPP-MMS- |
| | Version: |
| Message Type | X-Mms-Message-Type: |
| Transaction ID | X-Mms-Transaction-ID: |
| Message ID | X-Mms-Message-ID: |
| Recipient(s) address | To:, CC: |
| Sender address | From: |
| Content type | Content-Type: |
| Message class | X-Mms-Message-Class: |
| Date and time | Date: |
| Time of Expiry | X-Mms-Expiry: |
| Delivery report | X-Mms-Delivery-Report: |
| Priority | X-Mms-Priority: |
| Sender visibility | X-Mms-Sender-Visibility: |
| Read reply | X-Mms-Read-Reply: |
| Subject | Subject: |
| Acknowledgement | X-Mms-Ack-Request: |
| Request | |
| Content | <message body> |
| — | Sender: |
| — | Message-ID: |

The table above indicates the mappings from MM4_forward.REQ 1106 information elements to the corresponding STD 11 headers. The multimedia message Message-ID is not directly mapped to a corresponding STD 11 “Message-ID:” header. Each STD 11 message must have a unique message id, which is carried in the “Message-ID:” header. Content-type maps directly since both are defined as being MIME content types as specified in RFC 2046. The STD 11 “From:” header is determined by the mail user agent, or, in this case, the MMS User Agent. This corresponds to the multimedia message “Sender address”, as set by the MMS User Agent or MMS Relay/Server. STD 11 messages are required to have a Sender: header that indicates the originator address (as determined by the SMTP “MAIL From” command).

MM4_forward.RES Header Mappings—The MM4 Forward response information element mappings are detailed in the table below. The transmission of the Forward Response from the recipient MMS Relay/Server 1014 requires a properly addressed STD 11 message. While the addressing of the MM4_forward.REQ 1106 is clearly that of the intended recipients and originator, the MM4_forward.RES 1108 addressing is related to neither the recipients nor the originator of the original multimedia message. Instead, the MM4_forward.RES 1108 addressing is based on special systems addresses. MMS Service Provider should configure appropriate system addresses which will be used as both the recipient and originator of these administrative messages. It is suggested that the administrative addressing be based on the pattern:

system-user@mms-relay-host.mmse-domain.

TABLE 29
MM4_forward.RES 1108 Information
Elements to STD 11 Header Mappings

| Information element | STD Header |
|---|---|
| 3GPP MMS Version | X-Mms-3GPP-MMS- |
| | Version: |
| Message Type | X-Mms-Message-Type: |
| Transaction ID | X-Mms-Trans action-ID: |
| Message ID | X-Mms-Message-ID: |
| Request Status Code | X-Mms-Request-Status- |
| | Code: |
| Status text | X-Mms-Status-Text: |
| — | Sender: |
| — | To: |
| — | Message-ID: |
| — | Date: |

The Sender: and To: headers contain system addresses as described above, and do not map to MM4_forward.RES 1108 information elements. The STD 11 message requires a Date: header, but there currently is no corresponding MM4_forward.RES 1108 information element.

MM4_delivery_report.REQ 1120 Header Mappings—The mappings of the MM4_delivery_report.REQ 1120 information elements to STD 11 headers is detailed in the table below.

TABLE 30
MM4_delivery_report.REQ 1120
Information Elements to STD 11 Header Mappings

| Information element | STD 11 Header |
|---|---|
| 3GPP MMS Version | X-Mms-3GPP-MMS-Version: |
| Message Type | X-Mms-Message-Type: |
| Transaction ID | X-Mms-Transaction-ID: |
| MM Message ID | X-Mms-Message-ID: |
| Recipient address | From: |
| Sender address | To: |
| MM Date and time | Date: |
| Acknowledgement | X-Mms-Ack-Request: |
| Request | |
| MM Status Code | X-Mms-MM-Status-Code: |
| Status Text | X-Mms-Status-text: |
| — | Sender: |
| — | Message-ID: |

The meaning of Recipient address is that of the original multimedia message, from whose MMS User Agent this Delivery-report is being generated. The meaning of Sender address is that of the original multimedia message, to whom the Delivery-report is being sent. The value of the STD 11 Sender: header is a system administration address, to which the corresponding response will be sent. The Sender: header value is automatically set to the system address of the MMS Relay/Server. The Message-ID: value is automatically generated by the MMS Relay/Server, in conformance to STD 11. The other header mappings from information elements are similar to those already described above.

MM4_delivery_report.RES 1122 Header Mappings—The mappings of the M4_delivery_report.RES 1122 information elements to STD 11 headers is detailed in the table below.

TABLE 31
MM4_Delivery_report.RES Information Elements
to STD 11 Header Mappings

| Information element | STD 11 Header |
|---|---|
| 3GPP MMS Version | X-Mms-3GPP-MMS-Version: |
| MM Message Type | X-Mms-Message-Type: |
| Transaction ID | X-Mms-Transaction-ID: |
| Message ID | X-Mms-Message-ID: |
| Request Status Code | X-Mms-Request-Status-Code: |
| Status text | X-Mms-Status-Text: |
| — | Sender: |
| — | To: |
| — | Message-ID: |
| — | Date: |

The Sender: header value is automatically set to the system address of the MMS Relay/Server that is replying to the MM4_delivery_report.REQ 1120. The To: header value of the MM4_delivery_report.RES 1122 abstract message is obtained from the Sender: header value of the corresponding MM4_delivery_report.REQ 1120. The Date and Message-ID headers, which have no corresponding MM4_forward.RES 1108 information attributes, are automatically provided values by the MMS Relay/Server.

MM4_read_reply_report.REQ 1128 Header Mappings—The mappings of the MM4_read_reply_report.REQ 1128 information elements to STD 11 headers is detailed in the table below.

TABLE 32
MM4_read_reply_report.REQ 1126 Information
Elements to STD 11 Header Mappings.

| Information element | STD 11 Header |
|---|---|
| 3GPP MMS Version | X-Mms-3GPP-MMS-Version: |
| Message Type | X-Mms-Message-Type: |
| Transaction ID | X-Mms-Transaction-ID: |
| Recipient address | From: |
| Sender address | To: |
| Message-ID | X-Mms-Message-ID: |
| Date and time | Date: |
| Acknowledgement Request | X-Mms-Ack-Request: |
| MM Status Code | X-Mms-MM-Status-Code: |
| Status text | X-Mms-Status-Text: |
| — | Sender: |
| — | Message-ID: |
| — | Date: |

The meaning of Recipient address is that of the original multimedia message, from whose MMS User Agent this Read-reply-report is being generated. The meaning of Sender address is that of the original multimedia message, to whom the Read-reply-report is being sent. The value of the Sender: header is a system address, to which the corresponding MM4_read_reply_report.RES 1130 will be sent. The Message-ID:, and Date: headers, which have no corresponding information attribute in the MM4_read_reply_report.REQ 1128, are automatically provided appropriate values by the MMS Relay/Server.

MM4_read_reply_report.RES 1130 Header Mappings—The mappings of the MM4_read_reply_report.RES 1130 information elements to STD 11 headers is detailed in the table below.

TABLE 33
MM4_read_reply_report.RES 1130 Information
Elements to STD 11 Header Mappings.

| Information element | STD 11 Header |
|---|---|
| 3GPP MMS Version | X-Mms-3GPP-MMS-Version: |
| MM Message Type | X-Mms-Message-Type: |
| Transaction ID | X-Mms-Trans action-ID: |
| Request Status Code | X-Mms-Request-Status-Code: |
| Status text | X-Mms-Status-Text: |
| — | Sender: |
| — | To: |
| — | Message-ID: |
| — | Date: |

The Sender: header value will be the system address of the MMS Relay/Server that is replying to the MM4_delivery_report.REQ 1128. The To: header value of the MM4_delivery_report.RES 1130 abstract message will be obtained from the corresponding MM4_delivery_report.REQ 1128 Sender: header value. The Date: and Message-ID: headers, which do not have corresponding information elements, will be provided appropriate values automatically by the MMS Server/Relay.

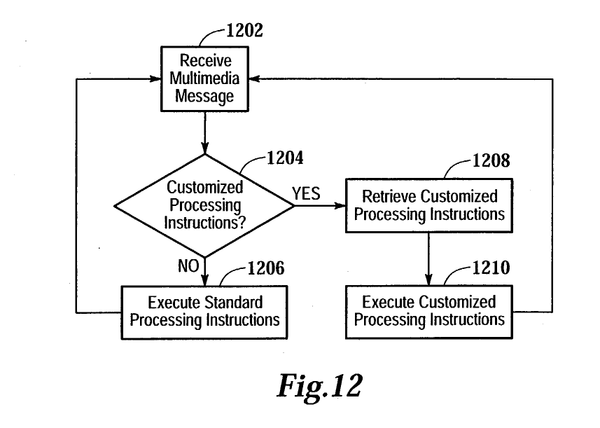

Now referring to FIG. 12 a flow chart of the MMC multimedia message processing is shown. Whenever a MMC receives a multimedia message from any source as shown in block 1202, the present invention determines whether the multimedia message should be processed using a customized process in decision block 1202. If the multimedia message should not be processed using a customized process, as determined in decision block 1204, the present invention processes the multimedia message by executing standard processing instructions corresponding to a standard process in block 1206. Thereafter, the present invention will go to block 1202 and receive the next multimedia message. If, however, the multimedia message should be processed using a customized process, as determined in decision block 1204, the present invention retrieves one or more customized processing instructions from a database in block 1208 and processes the multimedia message using the one or more customized processing instructions in block 1210. Thereafter, the present invention will go to block 1202 and receive the next multimedia message. This method can be implemented using a computer program embodied on a computer readable medium wherein each block represents a code segment.

The standard process and standardized processing instructions are the basic or minimum instructions required by a particular MMS to process a multimedia message. The multimedia message may include any of the messages described above in reference to FIGS. 10 and 11. As a result, some of the information elements will be dictated by standard processing instructions and others will be dictated by customized processing instructions.

The customized processing instructions may include all or part of the standard process or implement one or more subscriber preferences. The one or more subscriber preferences can be set by an originating subscriber of the multimedia message or set by a destination subscriber of the multimedia message. In addition, the customized processing instructions may include a delivery priority for the multimedia message, an instruction to forward the multimedia message to one or more other destinations, an instruction to copy and store the multimedia message on server, an instruction to send the multimedia message to an alternate destination if a destination device is not capable of receiving the multimedia message, or an instruction to store the multimedia message and not deliver the multimedia message to a destination device whenever the destination device is roaming.

Moreover, the customized processing instructions may implement one or more operator services, such as a prepay service plan, maintain a contracted quality of service, or a corporate service plan. The customized processing instructions may also comprise determining one or more multimedia capabilities of a destination device and modifying the multimedia message to be compatible with the destination device based on the one or more multimedia capabilities, or determining one or more multimedia capabilities of a destination device and reformatting the multimedia message to be compatible with the destination device based on the one or more multimedia capabilities. The customized processing instructions may also implement one or more licensing functions, such as verifying that a source device is authorized to send the multimedia message, verifying that a destination device is authorized to receive the multimedia message, restricting unauthorized copying of the multimedia message, limiting a transmission rate for the multimedia message, or delaying delivery of the multimedia message when a message throughput limit has been exceeded.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method for processing a multimedia message comprising the steps of:
receiving a multimedia message;
determining whether the multimedia message should be processed using a customized process;
retrieving one or more customized processing instructions from a database and processing the multimedia message using the one or more customized processing instructions whenever the multimedia message should be processed with the customized process; and
processing the multimedia message using a standard process whenever the multimedia message should not be processed using the customized process.

2. The method as recited in claim 1, wherein the customized processing instructions also includes all or part of the standard process.

3. The method as recited in claim 1, wherein the customized processing instructions implement one or more subscriber preferences.

4. The method as recited in claim 3, wherein the one or more subscriber preferences are set by an originating subscriber of the multimedia message.

5. The method as recited in claim 3, wherein the one or more subscriber preferences are set by a destination subscriber of the multimedia message.

6. The method as recited in claim 3, wherein the one or more subscriber preferences include a delivery priority for the multimedia message.

7. The method as recited in claim 3, wherein the one or more subscriber preferences include an instruction to forward the multimedia message to one or more other destinations.

8. The method as recited in claim 3, wherein the one or more subscriber preferences include an instruction to copy and store the multimedia message on a server.

9. The method as recited in claim 3, wherein the one or more subscriber preferences include an instruction to send the multimedia message to an alternate destination if a destination device is not capable of receiving the multimedia message.

10. The method as recited in claim 3, wherein the one or more subscriber preferences include an instruction to store the multimedia message and not deliver the multimedia message to a destination device whenever the destination device is roaming.

11. The method as recited in claim 1, wherein the customized processing instructions implement one or more operator services.

12. The method as recited in claim 11, wherein the one or more operator services includes a prepay service plan.

13. The method as recited in claim 11, wherein the one or more operator services maintain a contracted quality of service.

14. The method as recited in claim 11, wherein the one or more operator services includes a corporate service plan.

15. The method as recited in claim 1, wherein the customized processing instructions comprise determining one or more multimedia capabilities of a destination device and modifying the multimedia message to be compatible with the destination device based on the one or more multimedia capabilities.

16. The method as recited in claim 1, wherein the customized processing instructions comprise determining one or more multimedia capabilities of a destination device and reformatting the multimedia message to be compatible with the destination device based on the one or more multimedia capabilities.

17. The method as recited in claim 1, wherein the customized processing instructions implement one or more licensing functions.

18. The method as recited in claim 17, wherein the one or more licensing functions include verifying that a source device is authorized to send the multimedia message.

19. The method as recited in claim 17, wherein the one or more licensing functions include verifying that a destination device is authorized to receive the multimedia message.

20. The method as recited in claim 17, wherein the one or more licensing functions include restricting unauthorized copying of the multimedia message.

21. The method as recited in claim 17, wherein the one or more licensing functions include limiting a transmission rate for the multimedia message.

22. The method as recited in claim 17, wherein the one or more licensing functions include delaying delivery of the multimedia message when a message throughput limit has been exceeded.

23. A computer program embodied on a computer readable medium for processing a multimedia message comprising:
a code segment for receiving a multimedia message;
a code segment for determining whether the multimedia message should be processed using a customized process;
a code segment for retrieving one or more customized processing instructions from a database and processing the multimedia message using the one or more customized processing instructions whenever the multimedia message should be processed with the customized process; and
a code segment for processing the multimedia message using a standard process whenever the multimedia message should not be processed using the customized process.

24. The computer program as recited in claim 23, wherein the customized processing instructions also includes all or part of the standard process.

25. The computer program as recited in claim 23, wherein the customized processing instructions implement one or more subscriber preferences.

26. The computer program as recited in claim 25, wherein the one or more subscriber preferences are set by an originating subscriber of the multimedia message.

27. The computer program as recited in claim 25, wherein the one or more subscriber preferences are set by a destination subscriber of the multimedia message.

28. The computer program as recited in claim 25, wherein the one or more subscriber preferences include a delivery priority for the multimedia message.

29. The computer program as recited in claim 25, wherein the one or more subscriber preferences include an instruction to forward the multimedia message to one or more other destinations.

30. The computer program as recited in claim 25, wherein the one or more subscriber preferences include an instruction to copy and store the multimedia message on server.

31. The computer program as recited in claim 25, wherein the one or more subscriber preferences include an instruction to send the multimedia message to an alternate destination if a destination device is not capable of receiving the multimedia message.

32. The computer program as recited in claim 25, wherein the one or more subscriber preferences include an instruction to store the multimedia message and not deliver the multimedia message to a destination device whenever the destination device is roaming.

33. The computer program as recited in claim 23, wherein the customized processing instructions implement one or more operator services.

34. The computer program as recited in claim 33, wherein the one or more operator services includes a prepay service plan.

35. The computer program as recited in claim 33, wherein the one or more operator services maintain a contracted quality of service.

36. The computer program as recited in claim 33, wherein the one or more operator services includes a corporate service plan.

37. The computer program as recited in claim 23, wherein the customized processing instructions comprise determining one or more multimedia capabilities of a destination device and modifying the multimedia message to be compatible with the destination device based on the one or more multimedia capabilities.

38. The computer program as recited in claim 23, wherein the customized processing instructions comprise determining one or more multimedia capabilities of a destination device and reformatting the multimedia message to be compatible with the destination device based on the one or more multimedia capabilities.

39. The computer program as recited in claim 23, wherein the customized processing instructions implement one or more licensing functions.

40. The computer program as recited in claim 39, wherein the one or more licensing functions include verifying that a source device is authorized to send the multimedia message.

41. The computer program as recited in claim 39, wherein the one or more licensing functions include verifying that a destination device is authorized to receive the multimedia message.

42. The computer program as recited in claim 39, wherein the one or more licensing functions include restricting unauthorized copying of the multimedia message.

43. The computer program as recited in claim 39, wherein the one or more licensing functions include limiting a transmission rate for the multimedia message.

44. The computer program as recited in claim 39, wherein the one or more licensing functions include delaying delivery of the multimedia message when a message throughput limit has been exceeded.

45. A system for processing a multimedia message comprising:
a multimedia service relay;
a multimedia service server communicably coupled to the multimedia service relay;
a message storage device communicably coupled to the multimedia service server; and
a database communicably coupled to the multimedia service relay, the database containing one or more customized processing instructions.

46. The system as recited in claim 45, wherein the multimedia service relay receives a multimedia message, determines whether the multimedia message should be processed using a customized process, retrieves one or more customized processing instructions from the database and processes the multimedia message using the one or more customized processing instructions whenever the multimedia message should be processed with the customized process, and processes the multimedia message using a standard process whenever the multimedia message should not be processed using the customized process.

47. The system as recited in claim 46, wherein the customized processing instructions also includes all or part of the standard process.

48. The system as recited in claim 45, wherein the customized processing instructions implement one or more subscriber preferences.

49. The system as recited in claim 48, wherein the one or more subscriber preferences are set by an originating subscriber of the multimedia message.

50. The system as recited in claim 48, wherein the one or more subscriber preferences are set by a destination subscriber of the multimedia message.

51. The system as recited in claim 48, wherein the one or more subscriber preferences include a delivery priority for the multimedia message.

52. The system as recited in claim 48, wherein the one or more subscriber preferences include an instruction to forward the multimedia message to one or more other destinations.

53. The system as recited in claim 48, wherein the one or more subscriber preferences include an instruction to copy and store the multimedia message on server.

54. The system as recited in claim 48, wherein the one or more subscriber preferences include an instruction to send the multimedia message to an alternate destination if a destination device is not capable of receiving the multimedia message.

55. The system as recited in claim 48, wherein the one or more subscriber preferences include an instruction to store the multimedia message and not deliver the multimedia message to a destination device whenever the destination device is roaming.

56. The system as recited in claim 45, wherein the customized processing instructions implement one or more operator services.

57. The system as recited in claim 56, wherein the one or more operator services includes a prepay service plan.

58. The system as recited in claim 56, wherein the one or more operator services maintain a contracted quality of service.

59. The system as recited in claim 56, wherein the one or more operator services includes a corporate service plan.

60. The system as recited in claim 45, wherein the customized processing instructions comprise determining one or more multimedia capabilities of a destination device and modifying the multimedia message to be compatible with the destination device based on the one or more multimedia capabilities.

61. The system as recited in claim 45, wherein the customized processing instructions comprise determining one or more multimedia capabilities of a destination device and reformatting the multimedia message to be compatible with the destination device based on the one or more multimedia capabilities.

62. The system as recited in claim 45, wherein the customized processing instructions implement one or more licensing functions.

63. The system as recited in claim 62, wherein the one or more licensing functions include verifying that a source device is authorized to send the multimedia message.

64. The system as recited in claim 62, wherein the one or more licensing functions include verifying that a destination device is authorized to receive the multimedia message.

65. The system as recited in claim 62, wherein the one or more licensing functions include restricting unauthorized copying of the multimedia message.

66. The system as recited in claim 62, wherein the one or more licensing functions include limiting a transmission rate for the multimedia message.

67. The system as recited in claim 62, wherein the one or more licensing functions include delaying delivery of the multimedia message when a message throughput limit has been exceeded.

68. The system as recited in claim 45, further comprising:
one or more additional multimedia service relays communicably coupled to the multimedia service relay;
an additional multimedia service server communicably coupled to each additional multimedia service relay;
an additional message storage device communicably coupled to each additional multimedia service server; and
an additional database communicably coupled to each additional multimedia service relay, each additional database containing one or more customized processing instructions.

69. The system as recited in claim 45, further comprising one or more servers communicably coupled to the multimedia message service relay via a network.

70. The system as recited in claim 69, wherein the one or more servers include a unified messaging server.

71. The system as recited in claim 69, wherein the one or more servers include an electronic mail server.

72. The system as recited in claim 69, wherein the one or more servers include a multimedia content server.

73. The system as recited in claim 45, further comprising a short message service server communicably coupled to the multimedia message service relay.

74. The system as recited in claim 45, further comprising:
a gateway communicably coupled to the multimedia message service relay; and
one or more subscriber devices communicably coupled to the gateway via an access network.

75. The system as recited in claim 74, wherein the gateway is a push proxy gateway.

76. The system as recited in claim 74, wherein the gateway is a wireless application protocol gateway.

77. The system as recited in claim 75, further comprising a short message service server communicably coupled to the multimedia service relay, the gateway and the access network.

78. The system as recited in claim 75, further comprising a MARS communicably coupled to the multimedia service relay.
